(19) United States
(12) Patent Application Publication
(10) Pub. No.: US 2023/0266512 A1
(43) Pub. Date: Aug. 24, 2023

(54) Nanoparticle-Based Holographic Photopolymer Materials and Related Applications

(71) Applicant: DigiLens Inc., Sunnyvale, CA (US)

(72) Inventors: Gerald Buxton, Sunnyvale, CA (US); Shibu Abraham, Sunnyvale, CA (US); Richard E. Bergstrom, Jr., Hayward, CA (US); Alastair John Grant, San Jose, CA (US); Tsung-Jui Ho, Sunnyvale, CA (US); Baeddan George Hill, Sunnyvale, CA (US); Michiel Koen Callens, Sunnyvale, CA (US); Hua Gu, Sunnyvale, CA (US)

(73) Assignee: DigiLens Inc., Sunnyvale, CA (US)

(21) Appl. No.: 18/005,564

(22) PCT Filed: Jul. 14, 2021
(86) PCT No.: PCT/US2021/041673

§ 371 Date: Jan. 13, 2023

Related U.S. Application Data
(60) Provisional application No. 63/051,805, filed on Jul. 14, 2020.

(51) Int. Cl. G02B 5/18; G02B 6/34; G02F 1/13; G02F 1/1334; G11B 7/0065

(52) U.S. Cl. CPC G02B 5/1857; G02B 6/34; G02F 1/1326; G02F 1/13342; G11B 7/0065; G02B 2207/101

(57) ABSTRACT

Disclosed herein is a holographic mixture including nanoparticles used to form gratings through holographic exposure. In various embodiments, exposure of the holographic mixture causes the nanoparticles to diffuse to dark fringe regions which creates nanoparticle rich regions and nanoparticle poor regions. Some embodiments include a multi-layer grating which includes a layer formed through the exposed holographic mixture and another layer directly applied above the exposed holographic mixture. The other layer may also be exposed through a holographic recording beam.

### CROSS-REFERENCED APPLICATIONS

This application is a national stage application of PCT Application PCT/US2021/041673, entitled “Nanoparticle-Based Holographic Photopolymer Materials and Related Applications” filed on Jul. 14, 2021, which claims priority to U.S. Provisional Application 63/051,805 entitled “Nanoparticle-Based Holographic Photopolymer Materials and Related Applications” filed Jul. 14, 2020, the disclosure of which is incorporated herein by reference in its entirety.

### FIELD OF THE INVENTION

The present invention generally relates to holographic mixtures and, more specifically, to holographic mixture incorporating nanoparticles.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE DISCLOSURE

Various embodiments are directed to a method of forming a grating, the method including:

providing a starting cell comprising:

a bottom substrate;

a first removable substrate; and

a first holographic material comprising monomers and nanoparticles, wherein the first holographic material is positioned between the bottom substrate and the first removable substrate;

exposing the first holographic material with a holographic recording beam so the nanoparticles diffuse into dark fringe regions to create nanoparticle poor regions and nanoparticle rich regions to form a bottom grating;
removing the first removable substrate;
depositing a second holographic material on top of the exposed first holographic material;
positioning a second removable substrate on top of the second holographic material; and
exposing the second holographic material with another holographic recording beam to form a top grating.

In various other embodiments, the bottom grating and the top grating have different slant directions.

In still various other embodiments, the bottom grating and the top grating have the same slant direction.

In still various other embodiments, the second holographic material includes monomers and nanoparticle, and exposing the second holographic material diffuses the nanoparticles into dark fringe regions to create nanoparticle poor regions and nanoparticle rich regions.

In still various other embodiments, the second holographic material includes photopolymerizable monomers and inert liquid.

In still various other embodiments, the second holographic material further includes nanoparticles.

In still various other embodiments, the inert liquid comprises a liquid crystal material.

In still various other embodiments, the nanoparticles are dispersed within the liquid crystal material.

In still various other embodiments, the method further includes providing a release layer on the surface of the first removable substrate contacting the first holographic material.

In still various other embodiments, the release layer includes a silane-based fluoropolymer or fluoromonomer.

In still various other embodiments, exposing the first holographic material and the second holographic material with the holographic recording beam polymerizes the monomers to create a polymer matrix.

In still various other embodiments, the method further includes ashing the exposed first holographic material and second holographic material to remove at least a portion of the polymer matrix.

In still various other embodiments, the method further includes selectively etching a portion of the ashed first holographic material and second holographic material.

In still various other embodiments, the nanoparticles are selected from the group consisting of nanotubes, metals, insulators, ferroelectric materials, nanotubes, nanorods and nanospheres.

Further, various embodiments are directed to a method of forming a grating, the method including:

providing a starting cell including:

a bottom substrate;

a removable substrate; and

a holographic material comprising monomers and nanoparticles, where the holographic material is positioned between the bottom substrate and the removable substrate;

exposing the holographic material with a holographic recording beam so the nanoparticles diffuse into dark fringe regions to create nanoparticle poor regions and nanoparticle rich regions to form a grating;
removing the removable substrate; and
ashing the exposed holographic material to form a surface relief grating on top of a volume grating.

In various embodiments, the method further includes further ashing the exposed holographic material to form an inorganic grating structure made of the nanoparticles.

In still various other embodiments, the method further includes sintering the nanoparticles at a high temperature to remove grain boundaries between the nanoparticles.

In still various other embodiments, the method further includes coating an additional material onto the nanoparticles, where at least a portion of the additional material is positioned between adjacent nanoparticle rich regions.

In still various other embodiments, the method further includes depositing another holographic material on top of the additional material; and exposing the other holographic material with another holographic recording beam to create a top grating.

Further, various embodiments are directed to a waveguide device includes: a waveguide supporting an input grating and a fold grating, where the fold grating comprises alternating nanoparticle rich regions and nanoparticle poor regions, and where the input grating comprises alternating liquid crystal rich regions and liquid crystal poor regions.

In various other embodiments, the liquid crystal poor regions comprise air gaps.

In still various other embodiments, the nanoparticle poor regions comprise air gap regions on top of polymer matrix regions.

In still various other embodiments, the fold grating is an integrated multiplexed grating which functions as both a fold grating and an output grating.

In still various other embodiments, the alternating nanoparticle rich regions and nanoparticle poor regions include nanoparticles comprising a metal.

In still various other embodiments, the nanoparticles includes a metal oxide core.

In still various other embodiments, the metal oxide core comprises ZrO₂, TiO₂, WO₃, ZnO, Co₃O₄, CuO, and/or NiO.

In still various other embodiments, the nanoparticles further include a ligand functionalized derivative of ZrO₂, TiO₂, WO₃, ZnO, Co₃O₄, CuO, and/or NiO which surrounds the metal oxide core.

In still various other embodiments, the metal includes Pt, Au, and/or Ag.

In still various other embodiments, the nanoparticles are diameter less than 15 nm.

In still various other embodiments, the nanoparticles are diameter of about 4 nm to 10 nm.

In still various other embodiments, the alternating nanoparticle rich regions and nanoparticle poor regions include nanoparticles including a piezoelectric material.

In still various other embodiments, the piezoelectric material includes PZT, barium titanate, and/or lithium niobate.

Further, various embodiments are directed to a waveguide device including: a waveguide supporting a grating, wherein the grating comprises: nanoparticle rich regions and nanoparticle poor regions, wherein the nanoparticle poor regions comprise air gap regions on top of polymer matrix regions, wherein the air gap regions along with the nanoparticle rich regions on the same horizontal level make up a surface relief grating, and wherein the polymer matrix regions along with the nanoparticle rich regions on the same horizontal level make up a volume grating.

Further, various embodiments are directed to a waveguide device comprising: a waveguide supporting an inorganic grating, where the grating includes: nanoparticle rich regions, where nanoparticles in the nanoparticle rich regions are sintered at high temperature to remove grain boundaries between the nanoparticles; and air gaps between adjacent nanoparticle rich regions.

Further, various embodiments are directed to a waveguide device including: a waveguide supporting a multi-layered grating produced using the method described above.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a single-beam recording process utilizing a master grating in accordance with an embodiment of the invention.

FIGS. 2A and 2B conceptually illustrate HPDLC SBG devices and the switching property of SBGs in accordance with various embodiments of the invention.

FIG. 3 conceptually illustrates a waveguide display implementing integrated gratings in accordance with an embodiment of the invention.

FIG. 4 conceptually illustrates a waveguide with a grating layer having gratings formed from nanoparticle-based photopolymer materials in accordance with an embodiment of the invention.

FIG. 5 is a chart comparing diffraction efficiencies of various material formulations in accordance with various embodiments of the invention.

FIGS. 6A-6C conceptually illustrate general structures of components in the material formulations in accordance with various embodiments of the invention.

FIG. 7 conceptually illustrates a waveguide cell with defined grating areas containing different materials in accordance with an embodiment of the invention.

FIG. 8 is a flow chart conceptually illustrating a process for forming gratings using a holographic master grating in accordance with an embodiment of the invention.

FIGS. 9A-9E illustrates a process of forming a grating using holographic photopolymer materials including nanoparticles in accordance with an embodiment of the invention.

FIGS. 10A-10D illustrates a process forming a grating using holographic photopolymer materials including nanoparticles in accordance with an embodiment of the invention.

FIGS. 11A-11F illustrate a process of forming a grating using holographic photopolymer materials including nanoparticles and an inert liquid in accordance with an embodiment of the invention.

FIG. 12 illustrates a process for producing a grating in accordance with an embodiment of the invention.

FIGS. 13A-13C conceptually illustrate a process for manufacturing multi-layer gratings in accordance with an embodiment of the invention.

FIGS. 14A-14D conceptually illustrates a process for manufacturing multi-layer gratings in accordance with an embodiment of the invention.

FIGS. 15A-15G illustrates a process for manufacturing a multi-layer grating in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Holographic materials for use in the formation of waveguides, gratings, and other related applications in accordance with various embodiments of the invention can include a variety of different mixtures and formulations. In conventional holographic waveguide applications, the volume gratings within the waveguides are typically formed using holographic polymer dispersed liquid crystal (HPDLC) materials. Although convenient for many applications, such materials and the gratings formed from such materials have drawbacks that can be critical in certain cases. In addition to typical color non-uniformity and brightness concerns, HPDLC gratings may include the appearance of certain “defects” in the displayed images in some waveguide applications. Such defects can include dimmed patterns, such as but not limited to non-uniformity in the center or corner of the displayed images, and periodic non-uniformities that appear as a series of linear ridges, or striations. These defects may be rooted from the fundamental structure of the HPDLC gratings and can be difficult to address. For example, in typical waveguide applications implementing exit pupil expansion, a cause of striation defects in the displayed images may be related to the anisotropic nature of the HPDLC gratings. With each interaction of a given HPDLC grating, the polarization of the light may be slightly rotated. Given the polarization-sensitive diffractive nature of these gratings, light that continues to propagate within the waveguide and interacts with the grating again may be diffracted in an unexpected manner due to the change in its polarization state. For instance, many HPDLC material systems form gratings that have a high P-polarization response and a low S-polarization response. Unless otherwise stated, polarization response are described with respect to the plane of incidence. Waveguide display systems utilizing these gratings are often configured to utilize P-polarized input light. However, the polarization of the light “rotates” upon interaction with the grating. Light that interacts with the grating a second time, as is the case in grating architectures for implementing exit pupil expansion, may have a different diffraction efficiency profile—e.g., the light may have a lower P component upon the second interaction and may diffract less since the grating may have a high P-polarization response. This process may continue and the changes in the polarization may produce a cyclic diffraction efficiency profile that may manifest as striations and other defects.

The defects described above with regards to HPDLC gratings may often be unacceptable for commercial adoption. Furthermore, these defects may be more conspicuous in waveguide displays utilizing laser optical engines due to the coherence nature of laser illumination. As such, many embodiments of the invention are directed towards material systems capable of forming gratings with higher uniformity and less appearances of the defects described above. In many embodiments, the defects described above are eliminated as the gratings formed from such material systems may not affect the polarization of incident light. In some embodiments, the material system employed may be a nanoparticle-based photopolymer mixture. In some embodiments, the material system employed may be a mixture including at least one type of monomer and at least one type of nanoparticle for forming a photopolymer and nanoparticle material system after holographic exposure. In some embodiments, the starting mixture may further include at least one type of liquid crystal. In some embodiments, the role of the liquid crystal may not be to be removed from the grating after holographic exposure as is the case in EBGs but rather to improve refractive index modulation diffraction efficiency and electrooptical characteristics of the gratings in association with the nanoparticle component.

The mixture can be utilized in a holographic exposure process employing phase separation to form volume gratings. In several embodiments, the material mixture may be formulated to form volume gratings having high modulations of refractive indices. To address some of the drawbacks of gratings formed from HPDLC materials, photopolymer mixtures in accordance with various embodiments of the invention may include materials for forming isotropic gratings—e.g., gratings having no orientational or nematic order or gratings with random or isotropic domains—formed from alternating sections of polymers and nanoparticles. The type of nanoparticle chosen for use in the material system may be critical. For example, the material system can include various components such as but not limited to monomers, dyes, and coinitiators. The type of nanoparticle selected for use with such systems should advantageously have a low reactivity with the components within the systems. In various embodiments, the nanoparticles may have a high refractive index, which can be at least 1.7 in many cases. In several embodiments, the nanoparticles have high transmittance. For example, many types of nanoparticles utilized have transmittance values of at least 95%. In a number of embodiments, the type of nanoparticle selected has low absorption, allowing for implementation of an efficient waveguide display system. Various types of nanoparticles can be utilized. In many embodiments, the nanoparticles include inorganic core structures, such as but not limited to Au, Ag, Zr, Ti, Zn, and Cd cores. Functionalized and non-functionalized nanoparticles can be used as appropriate depending on the application. In some embodiments, the core structures may have surfaces modified with organic ligands. Such nanoparticles, which can also be referred to as nonmetallic nanoparticles, can be utilized to provide low absorption values. In other embodiments, metallic nanoparticles can also be utilized. Grating architectures, HPDLC material systems, nanoparticle-based material systems, methods for forming gratings using such material systems, and related applications are discussed in the sections below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. The gratings can be surface relief gratings that reside on the outer surface of the waveguide. In other cases, the grating implemented can be a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

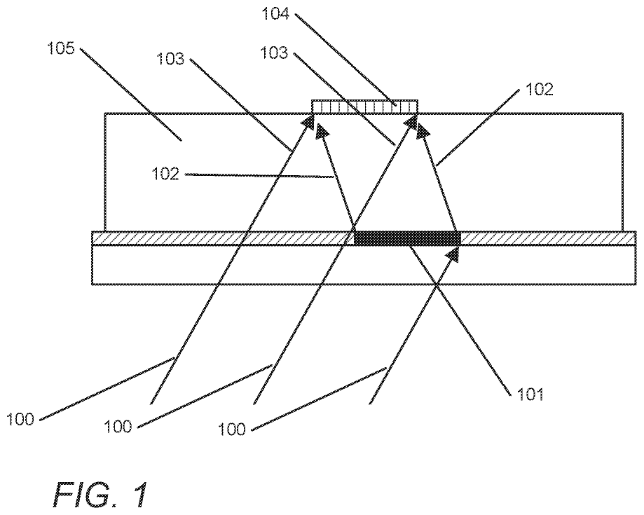

A single-beam recording process utilizing a master grating in accordance with an embodiment of the invention is conceptually illustrated in FIG. 1. As shown, a beam 100 from a single laser source (not shown) may be directed through an master grating 101. Upon interaction with the master grating 101, the beam 100 can diffract as, for example, in the case of the rays interacting with the black shaded region of the master grating 101, or the beam 100 can propagated through the master grating 101 without substantial deviation as a zero-order beam as, for example, in the case of the rays interacting with the cross-hatched region of the master grating 101. The first order diffraction beams 102 and the zero order beams 103 can overlap to create an interference pattern that exposes the optical recording layer 104 of a waveguide cell. In some embodiments, a spacer block 105 may be positioned between the grating 101 and the optical recording layer 104 in order to alter the distance between the two components.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. The substrates can also form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, exposure time, component volume fractions of the materials in the mixture, and exposure temperature can determine the resulting grating morphology and performance. As can readily be appreciated, a wide variety of materials and mixtures can be used depending on the specific requirements of a given application. In many cases, HPDLC material may be used to fabricate SBGs. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to low levels. Typically, the electrodes are configured such that the applied electric field may be perpendicular to the substrates. The electrodes may be fabricated from indium tin oxide (ITO) or other transparent conductive oxides (TCO). In some cases, index-matched ITO (IMITO) is used. In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state causing the extraordinary axes of the liquid crystal molecules to align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 100 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

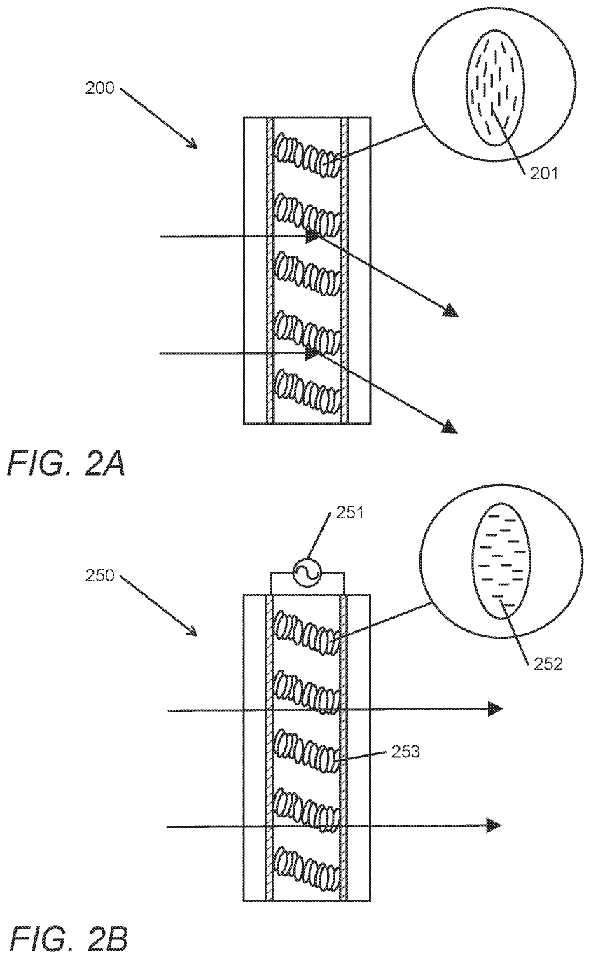

FIGS. 2A and 2B conceptually illustrate HPDLC SBG devices 200, 250 and the switching property of SBGs in accordance with an embodiment of the invention. In FIG. 2A, the SBG 200 is in an OFF state. As shown, the LC molecules 201 are aligned substantially normal to the fringe planes. As such, the SBG 200 exhibits high diffraction efficiency, and incident light can easily be diffracted. FIG. 2B illustrates the SBG 250 in an ON position. An applied voltage 251 can orient the optical axis of the LC molecules 252 within the droplets 253 to produce an effective refractive index that matches the polymer's refractive index, essentially creating a transparent cell where incident light is not diffracted. In the illustrative embodiment, an AC voltage source is shown. As can readily be appreciated, various voltage sources can be utilized depending on the specific requirements of a given application.

In some applications, LC can be extracted or evacuated from the SBG to provide an evacuated Bragg grating (EBG). EBGs can be characterized as a surface relief grating (SRG) that has properties very similar to a Bragg grating due to the depth of the

SRG structure (which may be much greater than that practically achievable using surface etching and other conventional processes commonly used to fabricate SRGs). Examples of EBGs are described in U.S. Pat. Pub. No. 2021/0063634 filed on Aug. 28, 2020 and entitled “Evacuating bragg gratings and methods of manufacturing” which is hereby incorporated by reference in its entirety. The LC can be extracted using a variety of different methods, including but not limited to flushing with solvents such as isopropyl alcohol. In many cases, one of the transparent substrates of the SBG may be removed, and the LC is extracted. The removed substrate can be replaced. The SRG can be at least partially backfilled with a material of higher or lower refractive index. Such gratings offer scope for tailoring the efficiency, angular/spectral response, polarization, and other properties to suit various waveguide applications.

### Waveguide Cells

A waveguide cell can be defined as a device containing uncured and/or unexposed optical recording material in which optical elements, such as but not limited to gratings, can be recorded. In many embodiments, optical elements can be recorded in the waveguide cell by exposing the optical recording material to certain wavelengths of electromagnetic radiation. A waveguide cell may be constructed such that the optical recording material may be sandwiched between two substrates, creating a three-layer waveguide cell. Depending on the application, waveguide cells can be constructed in a variety of configurations. In some embodiments, the waveguide cell may be constructed by vacuum filling an empty waveguide cell made of two substrates. Other filling methods can also be used. In several embodiments, the waveguide cell may be constructed by depositing the optical recording material onto one substrate and laminating the composite along with a second substrate to form a three-layer laminate. Various deposition techniques, such as but not limited to spin-coating and inkjet printing, can be used. In some embodiments, the waveguide cell may contain more than three layers. In a number of embodiments, the waveguide cell contains different types of layers that can serve various purposes. For example, waveguide cells can include protective cover layers, polarization control layers, and alignment layers.

Substrates of varying materials and shapes can be used in the construction of waveguide cells. In many embodiments, the substrates are plates made of a transparent material, such as but not limited to glass and plastics. Substrates of different shapes, such as but not limited to rectangular and curvilinear shapes, can be used depending on the application. The thicknesses of the substrates can also vary depending on the application. Oftentimes, the shapes of the substrates can determine the overall shape of the waveguide. In a number of embodiments, the waveguide cell contains two substrates that are of the same shape. In other embodiments, the substrates are of different shapes. As can readily be appreciated, the shapes, dimensions, and materials of the substrates can vary and can depend on the specific requirements of a given application.

In many embodiments, beads, or other particles, are dispersed throughout the optical recording material to help control the thickness of the layer of optical recording material and to help prevent the two substrates from collapsing onto one another. In some embodiments, the waveguide cell is constructed with an optical recording layer sandwiched between two planar substrates. Depending on the type of optical recording material used, thickness control can be difficult to achieve due to the viscosity of some optical recording materials and the lack of a bounding perimeter for the optical recording layer. In a number of embodiments, the beads are relatively incompressible solids, which can allow for the construction of waveguide cells with consistent thicknesses. The size of a bead can determine a localized minimum thickness for the area around the individual bead. As such, the dimensions of the beads can be selected to help attain the desired optical recording layer thickness. The beads can be made of any of a variety of materials, including but not limited to glass and plastics. In several embodiments, the material of the beads is selected such that its refractive index does not substantially affect the propagation of light within the waveguide cell.

In some embodiments, the waveguide cell may be constructed such that the two substrates are parallel or substantially parallel. In such embodiments, relatively similar sized beads can be dispersed throughout the optical recording material to help attain a uniform thickness throughout the layer. In other embodiments, the waveguide cell has a tapered profile. A tapered waveguide cell can be constructed by dispersing beads of different sizes across the optical recording material. As discussed above, the size of a bead can determine the local minimum thickness of the optical recording material layer. By dispersing the beads in a pattern of increasing size across the material layer, a tapered layer of optical recording material can be formed when the material is sandwiched between two substrates.

### Modulation of Material Composition

High luminance and excellent color fidelity may be beneficial factors in AR waveguide displays. In each case, high uniformity across the FOV can be beneficial. However, the fundamental optics of waveguides can lead to non-uniformities due to gaps or overlaps of beams bouncing down the waveguide. Further non-uniformities may arise from imperfections in the gratings and non-planarity of the waveguide substrates. In SBGs, there can exist a further issue of polarization rotation by birefringent gratings. In applicable cases, one challenge may be in fabrication of fold gratings where there may be millions of light paths resulting from multiple intersections of the beam with the grating fringes. Careful management of grating properties, particularly the refractive index modulation, can be utilized to overcome non-uniformity.

Out of the multitude of possible beam interactions (diffraction or zero order transmission), only a subset contributes to the signal presented at the eye box. By reverse tracing from the eyebox, fold regions contributing to a given field point can be pinpointed. The precise correction to the modulation that may send more into the dark regions of the output illumination can then be calculated. In some embodiments, correction to the modulation may be performed by adding a material of a certain refractive index/composition and coating depth to the spatial resolution cell contributing to the given field point. The type of material deposited can differ from the type of material used in the formation of other spatial resolution cells. Having brought the output illumination uniformity for one color back on target, the procedure can be repeated for other colors. Once the index modulation pattern has been established, the design can be exported to the deposition mechanism, with each target index modulation translating to a unique deposition setting for each spatial resolution cell on the substrate to be coated/deposited. The resolution of the deposition mechanism can depend on the technical limitations of the system utilized. In many embodiments, the spatial pattern can be implemented to 30 micrometers resolution with full repeatability.

Compared with waveguides utilizing surface relief gratings (SRGs), SBG waveguides implementing manufacturing techniques in accordance with various embodiments of the invention can allow for the grating design parameters that impact efficiency and uniformity, such as but not limited to refractive index modulation and grating thickness, to be adjusted dynamically during the deposition process without using a different master. With SRGs where modulation may be controlled by etch depth, such schemes would not be practical as each variation of the grating would entail repeating the complex and expensive tooling process. Additionally, achieving the desired etch depth precision and resist imaging complexity can be very difficult.

Deposition processes in accordance with various embodiments of the invention can provide for the adjustment of grating design parameters by controlling the type of material that is to be deposited. Various embodiments of the invention can be configured to deposit different materials, or different material compositions, in different areas on the substrate. For example, deposition processes can be configured to deposit HPDLC material onto an area of a substrate that is meant to be a grating region and to deposit monomer onto an area of the substrate that is meant to be a non-grating region. In some embodiments, the grating regions can be coated with a mixture of monomers, nanoparticles, and/or LC components. In several embodiments, the deposition process is configured to deposit a layer of optical recording material that varies spatially in component composition, allowing for the modulation of various aspects of the deposited material. The deposition of material with different compositions can be implemented in several different ways. In many embodiments, more than one deposition head can be utilized to deposit different materials and mixtures. Each deposition head can be coupled to a different material/mixture reservoir. Such implementations can be used for a variety of applications. For example, different materials can be deposited for grating and non-grating areas of a waveguide cell. In some embodiments, HPDLC material is deposited onto the grating regions while only monomer is deposited onto the non-grating regions. In several embodiments, the deposition mechanism can be configured to deposit mixtures with different component compositions.

In some embodiments, spraying nozzles can be implemented to deposit multiple types of materials onto a single substrate. In waveguide applications, the spraying nozzles can be used to deposit different materials for grating and non-grating areas of the waveguide. In many embodiments, the spraying mechanism is configured for printing gratings in which at least one of the material composition, birefringence, and/or thickness can be controlled using a deposition apparatus having at least two selectable spray heads. In some embodiments, the manufacturing system provides an apparatus for depositing grating recording material optimized for the control of laser banding. In several embodiments, the manufacturing system provides an apparatus for depositing grating recording material optimized for the control of polarization non-uniformity. In several embodiments, the manufacturing system provides an apparatus for depositing grating recording material optimized for the control of polarization non-uniformity in association with an alignment control layer. In a number of embodiments, the deposition workcell can be configured for the deposition of additional layers such as beam splitting coatings and environmental protection layers. Inkjet print heads can also be implemented to print different materials in different regions of the substrate.

As discussed above, deposition processes can be configured to deposit optical recording material that varies spatially in component composition. Modulation of material composition can be implemented in many different ways. In a number of embodiments, an inkjet print head can be configured to modulate material composition by utilizing the various inkjet nozzles within the print head. By altering the composition on a “dot-by-dot” basis, the layer of optical recording material can be deposited such that it has a varying composition across the planar surface of the layer. Such a system can be implemented using a variety of apparatuses including but not limited to inkjet print heads. Similar to how color systems use a palette of only a few colors to produce a spectrum of millions of discrete color values, such as the CMYK system in printers or the additive RGB system in display applications, inkjet print heads in accordance with various embodiments of the invention can be configured to print optical recording materials with varying compositions using only a few reservoirs of different materials. Different types of inkjet print heads can have different precision levels and can print with different resolutions. In many embodiments, a 300 DPI (“dots per inch”) inkjet print head is utilized. Depending on the precision level, discretization of varying compositions of a given number of materials can be determined across a given area. For example, given two types of materials to be printed and an inkjet print head with a precision level of 300 DPI, there are 90,001 possible discrete values of composition ratios of the two types of materials across a square inch for a given volume of printed material if each dot location can contain either one of the two types of materials. In some embodiments, each dot location can contain either one of the two types of materials or both materials. In several embodiments, more than one inkjet print head is configured to print a layer of optical recording material with a spatially varying composition. Although the printing of dots in a two-material application is essentially a binary system, averaging the printed dots across an area can allow for discretization of a sliding scale of ratios of the two materials to be printed. For example, the amount of discrete levels of possible concentrations/ratios across a unit square is given by how many dot locations can be printed within the unit square. As such, there can be a range of different concentration combinations, ranging from 100% of the first material to 100% of the second material. As can readily be appreciated, the concepts are applicable to real units and can be determined by the precision level of the inkjet print head. Although specific examples of modulating the material composition of the printed layer are discussed, the concept of modulating material composition using inkjet print heads can be expanded to use more than two different material reservoirs and can vary in precision levels, which largely depends on the types of print heads used.

Varying the composition of the material printed can be advantageous for several reasons. For example, in many embodiments, varying the composition of the material during deposition can allow for the formation of a waveguide with gratings that have spatially varying diffraction efficiencies across different areas of the gratings. In embodiments utilizing HPDLC mixtures, this can be achieved by modulating the relative concentration of liquid crystals in the HPDLC mixture during the printing process, which creates compositions that can produce gratings with varying diffraction efficiencies when the material is exposed. In several embodiments, a first HPDLC mixture with a certain concentration of liquid crystals and a second HPDLC mixture that is liquid crystal-free are used as the printing palette in an inkjet print head for modulating the diffraction efficiencies of gratings that can be formed in the printed material. In such embodiments, discretization can be determined based on the precision of the inkjet print head. A discrete level can be given by the concentration/ratio of the materials printed across a certain area. In this example, the discrete levels range from no liquid crystal to the maximum concentration of liquid crystals in the first PDLC mixture.

In some embodiments, the HPDLC mixture may include nanoparticles. The LC in the HPDLC mixture can remain within the final grating after holographic exposure as opposed to removed from the grating after holographic exposure as is the case for EBGs. Combining the properties of LCs and nanoparticles can be advantageous in various grating applications. Implementations including LCs and nanoparticles may be found in LC Hiroyuki Yoshida et al “Nanoparticle-Dispersed Liquid Crystals Fabricated by Sputter Doping” Adv. Mater. 2010, 22, 622-626 which is hereby incorporated by reference in its entirety. In some embodiments, nanoparticles can affect LC molecule orientation. The nanoparticles can be dispersed within the LC. Suitable nanoparticles for use with LCs may include metals, insulators, carbon nanotubes, and/or ferroelectric materials. As well as enabling high diffraction efficiency, nanoparticles can be used to control switching times and switching voltages. Capping agents can be used to promote solubility of nanoparticles within the host LC. Nanoparticles can be sputtered onto the host LC which may be applied using vacuum based processes.

The ability to vary the diffraction efficiency across a waveguide can be used for various purposes. A waveguide is typically designed to guide light internally by reflecting the light many times between the two planar surfaces of the waveguide. These multiple reflections can allow for the light path to interact with a grating multiple times. In many embodiments, a layer of material can be printed with varying composition of materials such that the gratings formed have spatially varying diffraction efficiencies to compensate for the loss of light during interactions with the gratings to allow for a uniform output intensity. For example, in some waveguide applications, an output grating is configured to provide exit pupil expansion in one direction while also coupling light out of the waveguide. The output grating can be designed such that when light within the waveguide interact with the grating, only a percentage of the light is refracted out of the waveguide. The remaining portion continues in the same light path, which remains within TIR and continues to be reflected within the waveguide. Upon a second interaction with the same output grating again, another portion of light is refracted out of the waveguide. During each refraction, the amount of light still traveling within the waveguide decreases by the amount refracted out of the waveguide. As such, the portions refracted at each interaction gradually decreases in terms of total intensity. By varying the diffraction efficiency of the grating such that it increases with propagation distance, the decrease in output intensity along each interaction can be compensated, allowing for a uniform output intensity.

Varying the diffraction efficiency can also be used to compensate for other attenuation of light within a waveguide. All objects have a degree of reflection and absorption. Light trapped in TIR within a waveguide are continually reflected between the two surfaces of the waveguide. Depending on the material that makes up the surfaces, portions of light can be absorbed by the material during each interaction. In many cases, this attenuation is small, but can be substantial across a large area where many reflections occur. In many embodiments, a waveguide cell can be printed with varying compositions such that the gratings formed from the optical recording material layer have varying diffraction efficiencies to compensate for the absorption of light from the substrates. Depending on the substrates, certain wavelengths can be more prone to absorption by the substrates. In a multi-layered waveguide design, each layer can be designed to couple in a certain range of wavelengths of light. Accordingly, the light coupled by these individual layers can be absorbed in different amounts by the substrates of the layers. For example, in a number of embodiments, the waveguide is made of a three-layered stack to implement a full color display, where each layer is designed for one of red, green, and blue. In such embodiments, gratings within each of the waveguide layers can be formed to have varying diffraction efficiencies to perform color balance optimization by compensating for color imbalance due to loss of transmission of certain wavelengths of light.

In addition to varying the liquid crystal concentration within the material in order to vary the diffraction efficiency, another technique includes varying the thickness of the waveguide cell. This can be accomplished through the use of spacers. In many embodiments, spacers are dispersed throughout the optical recording material for structural support during the construction of the waveguide cell. In some embodiments, different sizes of spacers are dispersed throughout the optical recording material. The spacers can be dispersed in ascending order of sizes across one direction of the layer of optical recording material. When the waveguide cell is constructed through lamination, the substrates sandwich the optical recording material and, with structural support from the varying sizes of spacers, create a wedge-shaped layer of optical recording material. spacers of varying sizes can be dispersed similar to the modulation process described above. Additionally, modulating spacer sizes can be combined with modulation of material compositions. In several embodiments, reservoirs of HPDLC materials each suspended with spacers of different sizes are used to print a layer of HPDLC material with spacers of varying sizes strategically dispersed to form a wedge-shaped waveguide cell. In a number of embodiments, spacer size modulation is combined with material composition modulation by providing a number of reservoirs equal to the product of the number of different sizes of spacers and the number of different materials used. For example, in one embodiment, the inkjet print head is configured to print varying concentrations of liquid crystal with two different spacer sizes. In such an embodiment, four reservoirs can be prepared: a liquid crystal-free mixture suspension with spacers of a first size, a liquid crystal-free mixture-suspension with spacers of a second size, a liquid crystal-rich mixture-suspension with spacers of a first size, and a liquid crystal-rich mixture-suspension with spacers of a second size. Further discussion regarding material modulation can be found in U.S. application Ser. No. 16/203,071 filed Nov. 18, 2018 entitled “SYSTEMS AND METHODS FOR MANUFACTURING WAVEGUIDE CELLS.” The disclosure of U.S. application Ser. No. 16/203,491 is hereby incorporated by reference in its entirety for all purposes.

### Waveguides Incorporating Integrated Gratings

Waveguides in accordance with various embodiments of the invention can include different grating configurations. In many embodiments, the waveguide includes at least one input coupler and at least two integrated gratings. In some embodiments, at least two integrated gratings can be implemented to work in combination to provide beam expansion and beam extraction for light coupled into the waveguide by the input coupler. Multiple integrated gratings can be implemented by overlapping integrated gratings across different grating layers or by multiplexing the integrated gratings. In a number of embodiments, the integrated gratings are partially overlapped or multiplexed. Multiplexed gratings can include the superimposition of at least two gratings having different grating prescriptions within the same volume. Gratings having different grating prescriptions can have different grating vectors (grating K-vector) and grating slant angle with respect to the waveguide's surface. The magnitude of the grating vector of a grating can be defined as the inverse of the grating period while its direction can be defined as the direction orthogonal to the fringes of the grating.

In several embodiments, an integrated grating can be implemented to perform both beam expansion and beam extraction. An integrated grating can be implemented with one or more grating prescriptions. In a number of embodiments, the integrated grating is implemented with at least two grating prescriptions. In further embodiments, the integrated grating is implemented with at least three grating prescriptions. In many embodiments, two grating prescriptions within the integrated grating have similar clock angles. In some embodiments, the two grating prescriptions have different slant angles. An integrated grating in accordance with various embodiments of the invention can be implemented using a variety of types of gratings, such as but not limited to SRGs, SBGs, holographic gratings, and other types of gratings including those described in the sections above. In a number of embodiments, the integrated grating includes two surface relief gratings. In other embodiments, the integrated grating includes two holographically-recorded gratings.

The integrated grating can include at least two grating prescriptions that are implemented in separate least partially overlapped layers or multiplexed into one layer. In further embodiments, the integrated grating includes at least two grating prescriptions that are fully overlapped or multiplexed. In a number of embodiments, the integrated grating includes multiplexed or overlapping gratings that have different sizes and/or shapes—i.e., one grating may be larger than the other, resulting in only partial multiplexing of the larger grating. As can readily be appreciated, various multiplexed and overlapping configurations may be implemented as appropriate depending on the specific requirements of a given application. In some embodiments, a given ray may enter the waveguide along its waveguide path encountering regions containing a grating integrated according to any of the above configurations or no grating at all. Although the discussions below may describe configurations as implementing multiplexed or overlapping gratings, such gratings can be substituted for one another as appropriate depending on the application. In several embodiments, the integrated gratings are implemented by a combination of both multiplexed and overlapping gratings. For example, two or more sets of multiplexed gratings can be overlapped across two or more grating layers.

Integrated gratings in accordance with various embodiments of the invention can be utilized for various purposes including but not limited to implementing full color waveguides and addressing some key problems in conventional waveguide architectures. Other advantages include reduced material and waveguide refractive index requirements and reduced waveguide dimensions resulting from the overlapping and/or multiplexing nature of the integrated gratings. Such configurations can allow for large field-of-view waveguides, which would ordinarily incur unacceptable increases in waveguide form factor and refractive index requirements. In many embodiments, a waveguide is implemented with at least one substrate having a low refractive index. In some embodiments, the waveguide is implemented with a substrate having a refractive index of lower than 1.8. In further embodiments, the waveguide is implemented with a substrate having a refractive index of not more than ˜1.5.

Integrated gratings that can provide beam expansion and beam extraction—i.e., the functions of conventional fold and output gratings—can result in a much smaller grating area, enabling a small form factor and lower fabrication cost. By integrating the functions of beam expansion and extraction, instead of performing them serially as in traditional waveguides, beam expansion and extraction can be accomplished with ˜50% of the grating interactions normally required, cutting down haze in the same proportion in the case of birefringent gratings. A further advantage is that, as a result of the greatly shortened light paths, the number of beam bounces at glass/air interface(s) is reduced, rendering the output image less sensitive to substrate nonuniformities. This can enable higher quality images and the potential to use less expensive, lower specification substrates.

In many embodiments, the grating vectors of the input coupler and integrated gratings are arranged to provide a substantially zero resultant vector. The grating vectors of the input coupler and integrated gratings can be arranged to form a triangular configuration. In several embodiments, the grating vectors can be arranged in an equilateral triangular configuration. In some embodiments, the grating vectors can be arranged in an isosceles triangular configuration where at least two grating vectors have equal magnitudes. In further embodiments, the grating vectors are arranged in an isosceles right triangular configuration. In a number of embodiments, the grating vectors are arranged in a scalene triangular configuration. Another waveguide architecture includes integrated diffractive elements with grating vectors aligned in the same direction for providing horizontal expansion for one set of angles and extraction for a separate set of angles. In several embodiments, one or more of the integrated gratings are asymmetrical in their general shape. In some embodiments, one or more of the integrated gratings has at least one axis of symmetry in their general shape. In a number of embodiments, the gratings are designed to sandwich an electro-active material, enabling switching between clear and diffracting states for certain types of gratings such as but not limited to HPDLC gratings. The gratings can be a surface relief or a holographic type.

In many embodiments, a waveguide supporting at least one input coupler and first and second integrated gratings is implemented. The grating structures can be implemented in single- or multi-layered waveguide designs. In single-layered designs, the integrated gratings can be multiplexed. In embodiments where each integrated grating contains at least two multiplexed gratings, the multiplexed integrated gratings can contain at least four multiplexed gratings. As described above, any individual multiplexed grating can be partially or completely multiplexed with the other gratings. In some embodiments, a multi-layered waveguide is implemented with overlapping integrated gratings. In further embodiments, the integrated gratings are partially overlapped. Each of the integrated gratings can be a separate grating or multiplexed gratings.

In many embodiments, the waveguide architecture is designed to couple the input light into two bifurcated paths using an input coupler. Such configurations can be implemented in various ways. In some embodiments, a multiplexed input grating is implemented to couple input light into two bifurcated paths. In other embodiments, two input gratings are implemented to separately couple input light into two bifurcated paths. The two input gratings can be implemented in the same layer or separately in two layers. In a number of embodiments, two overlapping or partially overlapping input gratings are implemented to couple input light into two bifurcated paths. In many embodiments, the input coupler includes a prism. In further embodiments, the input coupler includes a prism and any of the input grating configuration described above.

In addition to various input coupler architectures, the first and second integrated gratings can be implemented in a variety of configurations. Integrated gratings in accordance with various embodiments of the invention can be incorporated into waveguides to perform the dual function of two-dimensional beam expansion and beam extraction. In several embodiments, the first and second integrated gratings are crossed gratings. As described above, some waveguide architectures include designs in which input light is coupled into two bifurcated paths. In such designs, the two bifurcated paths are each directed towards a different integrated grating. As can readily be appreciated, such configurations can be designed to bifurcate the input light based on various light characteristics, including but not limited to angular and spectral bandwidths. In some embodiments, light can be bifurcated based on polarization states—e.g., input unpolarized light can be bifurcated into S and P polarization paths. In many embodiments, each of the integrated gratings performs either beam expansion in a first direction or beam expansion in a second direction different from the first direction according to the field-of-view portion being propagated through the waveguide. The first and second directions can be orthogonal to one another. In other embodiments, the first and second directions are not orthogonal to one another. Each integrated grating can provide expansion of the light in a first dimension while directing the light towards the other integrated grating, which provides expansion of the light in a second dimension and extraction. For example, many grating architectures in accordance with various embodiments of the invention include an input configuration for bifurcating input light into first and second portions of light. A first integrated grating can be configured to provide beam expansion in a first direction for the first and second portions of light and to provide beam extraction for the second portion of light. Conversely, the second integrated grating can be configured to provide beam expansion in a second direction for the first and second portions of light and to provide beam extraction for the first portion of light.

In a number of embodiments, the first integrated grating includes multiplexed first and second grating prescriptions, and the second integrated grating includes multiplexed third and fourth grating prescriptions. In such embodiments, the first grating prescription can be configured to provide beam expansion in a first direction for the first portion of light and to redirect the expanded light towards the fourth grating prescription. The second grating prescription can be configured to provide beam expansion in the first direction for the second portion of light and to extract the light out of the waveguide. The third grating prescription can be configured to provide beam expansion in a second direction for the second portion of light and to redirect the expanded light towards the second grating prescription. The fourth grating prescription can be configured to provide beam expansion in the second direction for the first portion of light and to extract the light out of the waveguide. As can readily be appreciated, the integrated gratings can be implemented with overlapping grating prescriptions instead of multiplexed grating prescriptions. In many embodiments, the first and second grating prescriptions have the same clock angle but different grating slants. In some embodiments, the third and fourth grating prescriptions have the same clock angle, which is different from the clock angles of the first and second grating prescriptions. In a number of embodiments, the first, second, third, and fourth grating prescriptions all have different clock angles. In several embodiments, the first, second, third, and fourth grating prescriptions all have different grating periods. In a number of embodiments, the first and third grating prescriptions have the same grating period, and the second and fourth grating prescriptions have the same grating period.

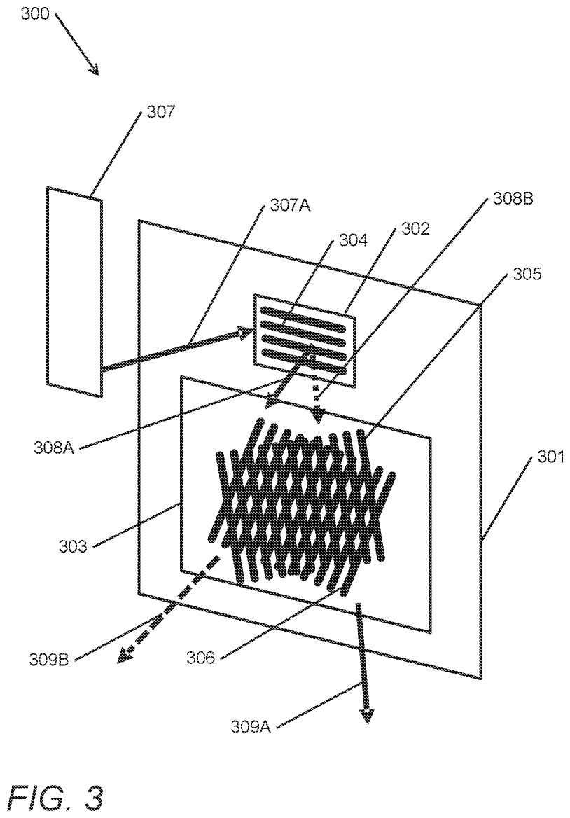

FIG. 3 conceptually illustrates a waveguide display implementing integrated gratings in accordance with an embodiment of the invention. As shown, the apparatus 300 includes a waveguide 301 supporting an input grating 302 and a grating structure 303. Each grating can be characterized by a grating vector defining the orientation of the grating fringes in the plane of the waveguide. A grating can also be characterized by a K-vector in 3D space, which in the case of a Bragg grating is defined as the vector normal to the grating fringes. The waveguide reflecting surfaces are parallel to the XY plane of the Cartesian reference frame inset into the drawing. In some embodiments, the X and Y axes can correspond to global horizontal and vertical axes in the reference frame of a user of the display.

In the illustrative embodiment of FIG. 3, the input grating 302 includes a Bragg grating 304. In other embodiments, the input grating 302 is a surface relief grating. The input grating 302 can be implemented to bifurcate input light into two different portions. In further embodiments, the input grating 302 includes two multiplexed gratings having different grating prescriptions. In other embodiments, the input grating 302 includes two overlaid surface relief gratings. The grating structure 303 includes two effective gratings 305, 306 that have different grating vectors. The gratings 305, 306 can be integrated gratings implemented as surface relief gratings or volume gratings. In many embodiments, the gratings 305, 306 are multiplexed in a single layer. In several embodiments, the waveguide 301 provides two effective gratings at all points across the grating structure 303 by overlaying more than two separated gratings in the grating structure. For ease of clarity, the gratings 305, 306 that form the grating structure 303 will be referred to as first and second integrated gratings since their role in the grating structure includes providing beam expansion by changing the direction of the guided beam in the plane of the waveguide and beam extraction. In various embodiments, the integrated gratings 305, 306 perform two-dimensional beam expansion and extraction of light from the waveguide 301. The field-of-view coupled into the waveguide can be partitioned into first and second portions, which can be bifurcated as such by the input grating 302. In many embodiments, the first and second portions correspond to positive and negative angles, vertically or horizontally. In some embodiments, the first and second portions may overlap in angle space. In a number of embodiments, the first portion of the field-of-view is expanded in a first direction by the first integrated grating and, in a parallel operation, expanded in a second direction and extracted by the second integrated grating. When a ray interacts with a grating fringe, some of the light that meets the Bragg condition is diffracted while non-diffracted light proceeds along its TIR path up to the next fringe, continuing the expansion and extraction process. Considering next the second portion of the field-of-view, the role of the gratings is reversed such that the second portion of the field is expanded in the second direction by the second integrated grating and expanded in the first direction and extracted by the first integrated grating.

In many embodiments, the integrated gratings 305, 306 in the grating structure 303 can be asymmetrically disposed. In some embodiments, the integrated gratings 305, 306 have grating vectors of different magnitudes. In several embodiments, the input grating 302 can have a grating vector offset from the Y-axis. In a number of embodiments, it is desirable that the vector combination of the grating vectors of the input grating 302 and the integrated gratings 305, 306 in the grating structures 303 gives a resultant vector of substantially zero magnitude. As described above, the grating vectors can be arranged in an equilateral, isosceles, or scalene triangular configuration. Depending on the application, certain configurations may be more desirable.

In many embodiments, at least one grating parameter selected from the group of grating vector direction, K-vector direction, grating refractive index modulation, and grating spatial frequency can vary spatially across at least one grating implemented in the waveguide for the purposes of optimizing angular bandwidth, waveguide efficiency, and output uniformity to increase the angular response and/or efficiency. In some embodiments, at least one of the gratings implemented in the waveguide can employ rolled K-vectors—i.e., spatially varying K-vectors. In several embodiments, the spatial frequencies of the grating(s) are matched to overcome color dispersion.

The apparatus 300 of FIG. 3 further includes an input image generator. In the illustrative embodiment, the input image generator includes a laser scanning projector 307 that provides a scanned beam 307A over a field-of-view that is coupled into total internal reflection paths (TIR paths) (308A, 308B, for example) in the waveguide by the input grating 302 and is directed towards the integrated gratings 305, 306 to be expanded and extracted (as shown by rays 309A, 309B, for example). In some embodiments, the laser projector 307 is configured to inject a scanned beam into the waveguide. In several embodiments, the laser projector 307 can have a scan pattern modified to compensate for optical distortions in the waveguide. In a number of embodiments, the laser scanning pattern and/or grating prescriptions in the input grating 302 and grating structure 303 can be modified to overcome illumination banding. In various embodiments, the laser scanning projector 307 can be replaced by an input image generator based on a reflective or transmissive microdisplay illuminated by a laser or an LED. In many embodiments, the input image can be provided by an emissive display. A laser projector can offer the advantages of improved color gamut, higher brightness, wider field-of-view, high resolution, and a very compact form factor. In some embodiments, the apparatus 300 can further include a despeckler. In further embodiments, the despeckler can be implemented as a waveguide device. Although FIG. 3 shows a specific waveguide application implementing integrated gratings, such structures and grating architectures can be utilized for various applications. In a number of embodiments, a waveguide having integrated gratings can be implemented in a single grating layer for a full color application. In many embodiments, more than one grating layer implementing integrated gratings are implemented. Such configurations can be implemented to provide wider angular or spectral bandwidth operation. In some embodiments, a multi-layered waveguide is implemented to provide a full color application. In several embodiments, a multi-layered waveguide is implemented to provide a wider field-of-view. In many embodiments, a full color waveguide having at least a ˜50° diagonal field-of-view is implemented using integrated gratings. In some embodiments, a full color waveguide having at least a ˜100° diagonal field-of-view is implemented using integrated gratings. Further discussion regarding integrated gratings can be found in U.S. application Ser. No. 16/794,071 filed Feb. 18, 2020 entitled “Methods and Apparatuses for Providing a Holographic Waveguide Display Using Integrated Gratings.” The disclosure of U.S. application Ser. No. 16/794,071 is hereby incorporated by reference in its entirety for all purposes.

### HPDLC Optical Recording Material Systems

HPDLC mixtures may include LC, monomers, photosensitive dyes, and coinitiators. The mixture (often referred to as syrup) frequently may include a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:

R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

### Nanoparticle-Based Optical Recording Material Systems

Material systems in accordance with various embodiments of the invention can include photopolymer mixtures capable of forming holographic Bragg gratings. In a number of embodiments, the mixtures are able to form holographic gratings using interferential photolithography. In such cases, the index modulation may be created by the varying exposure intensity of the interference pattern. Any of a variety of lithographic techniques, including those described in the sections above and those well-known in the art, can be used. Compared to other techniques relying on index changes through photo-reactivity, material systems and techniques in accordance with various embodiments of the invention utilize diffusion processes initiated through interferential exposure.

In many embodiments, the photopolymer mixture may include different types of monomers, dyes, photoinitiators, and nanoparticles. Monomers can include but are not limited to vinyls, acrylates, methacrylates, thiols, epoxides, and other reactive groups. In some embodiments, the mixture can include monomers having different refractive indices. In several embodiments, the mixture can include reactive or non-reactive diluents and/or adhesion promoters.

As can readily be appreciated, various types of mixtures and compositions can be implemented as appropriate depending on the specific requirements of a given application. In a number of embodiments, the mixture implemented is based on material systems described in U.S. Pat. App. Pub. No. 2019/0212597 entitled “Low Haze Liquid Crystal Materials” filed Jan. 8, 2019, U.S. Pat. App. Pub. No. 2019/0212589 entitled “Liquid Crystal Materials and Formulations” filed Jan. 8, 2019, U.S. Pat. App. Pub. No. 2019/0212596 entitled “Holographic Material Systems and Waveguides Incorporating Low Functionality Monomers” filed Jun. 13, 2018, and U.S. Pat. App. Pub. No. 2020/0271973 entitled “Holographic Polymer Dispersed Liquid Crystal Mixtures with High Diffraction Efficiency and Low Haze” filed Feb. 24, 2020. The disclosures of U U.S. Pat. App. Pub. Nos. 2019/0212597, 2019/0212589, 2019/0212596, and 2020/0271973 are hereby incorporated by reference in their entireties for all purposes.

To form holographic gratings, a master grating can be used to direct an exposure beam and to form an interferential pattern onto a layer of uncured photopolymer material to form gratings. As described above, the recording process can be performed on a waveguide cell that includes a layer of uncured photopolymer material sandwiched by two transparent substrates, which are typically made of plastic or glass plates. The waveguide cell with the layer of uncured photopolymer material can be formed in many different ways, including but not limited to vacuum filling and printing deposition processes. By exposing the master grating with a recording beam, a portion of the beam diffracts while a portion passes through as zero-order light. The diffracted portion and the zero-order portion can interfere to expose the photopolymer material. The monomers and nanoparticles phase separate to form alternating regions of monomers and nanoparticles corresponding to the interference pattern, effectively forming a volume Bragg grating. In a number of embodiments, two different exposure beams are utilized to form the interference pattern for the desired exposure.

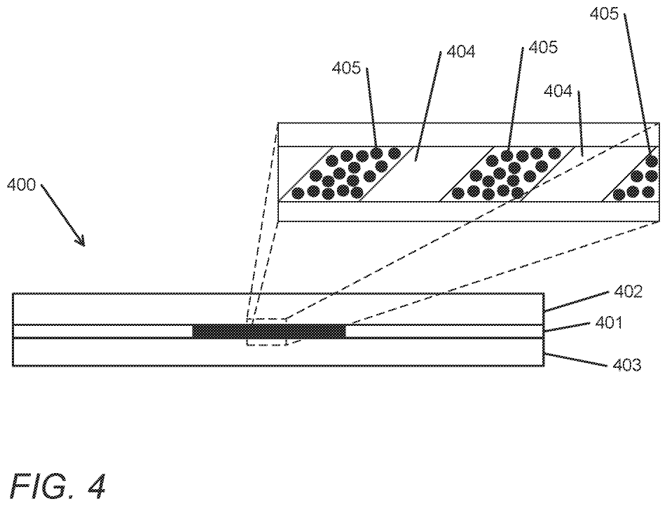

FIG. 4 conceptually illustrates a waveguide with a grating layer having gratings formed from nanoparticle-based photopolymer materials in accordance with an embodiment of the invention. As shown, the waveguide 400 includes a grating layer 401 sandwiched by two transparent substrates 402, 403. The grating layer 401 may include gratings formed of alternating regions of monomers 404 and nanoparticles 405.

Depending on the application, the type and size of the formed gratings can differ widely. In several embodiments, the nanoparticle-based photopolymer system may be implemented to form isotropic gratings. Isotropic gratings can be advantageous in many different waveguide applications. As described in the sections above, anisotropic gratings, such as those formed from HPDLC material systems, can produce a polarization rotation effect on light propagating within the waveguide, resulting in striations and other undesirable artifacts. Waveguides incorporating isotropic gratings can eliminate many of these artifacts, improving light uniformity. In many embodiments, the nanoparticle-based gratings have may high diffraction efficiencies for both S- and P-polarized light, which enable more uniform and efficient waveguides compared to typical HPDLC gratings. In some embodiments, the gratings may provide diffraction efficiencies of at least ˜20% for at least one of S- and P-polarized light. In further embodiments, the gratings provide diffraction efficiencies of at least ˜40% for at least one of S- and P-polarized light. As can readily be appreciated, such gratings can be configured with the appropriate polarized response depending on the specific requirements of a given application. For example, in a number of embodiments, the gratings provide at least ˜40% diffraction efficiency for S-polarized light to implement a waveguide display with adequate brightness. In further embodiments, the gratings provide at least ˜40% diffraction efficiency for S-polarized light and at least ˜10% diffraction efficiency for P-polarized light.

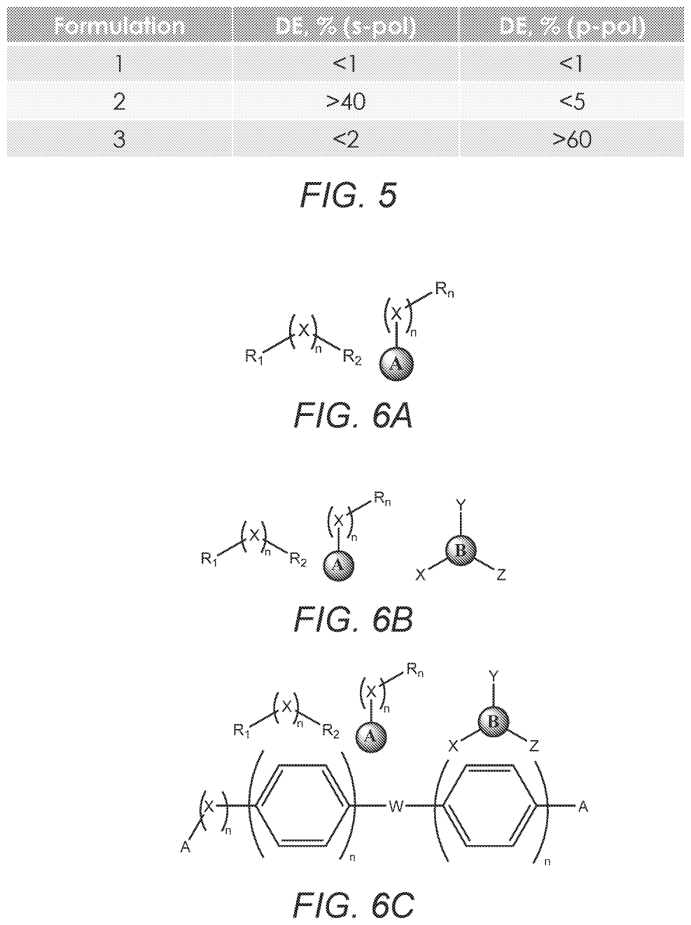

FIG. 5 is a chart comparing diffraction efficiencies of various material formulations in accordance with various embodiments of the invention. As shown, mixtures in accordance with various embodiments of the invention can be formulated for specific purposes. For example, Formulation 1 shows a material system with low diffraction efficiencies for S- and P-polarized light while Formulation 2 shows a material system with a sufficiently high diffraction efficiency responses for both S- and P-polarized light, with the system being primarily S-sensitive. Formulation 3 is a material system based on HPDLC materials, which exhibits a high diffraction efficiency response for P-polarized light.

FIGS. 6A-6C conceptually illustrates general structures of components in the material formulations listed in FIG. 5 in accordance with various embodiment of the invention. The components in the material formulations may include but are not limited to nanoparticles, liquid crystal monomers, pendant chains aromatic and/or aliphatic, linking groups and other functionalities. FIG. 6A illustrates a chemical formula for a mixture of monomers with similar reactivity and diffusional rate constants which may results in inefficient phase separation. The mixture of monomers corresponds to Formulation 1 of FIG. 5. In some embodiments, the addition of capped nanoparticles or liquid crystals may improve phase separation. FIG. 6B illustrates a mixture of monomers which corresponds to the Formulation 2 of FIG. 5. FIG. 6C illustrates a mixture of monomers which corresponds to Formulation 3 of FIG. 5. Specific types of LCs and their derivatives may be found through this application. In FIGS. 6A-6C, different symbols represent but are not limited to:

Rn may be —H, alkyl, alkoxy or monomers; n may be an integer value such as 0, 1, etc.;
X, Y, Z may be —H, monomers, spacers, or ligands;
A may be Rn, functional groups, or pendants (aliphatic or aromatic);
B may be high index cores with or without capping agents; and
W may be linking groups.

For example, waveguide applications typically utilize subwavelength-sized gratings to enable the desired propagation and control of light within the waveguide. As such, several embodiments of the invention include the use of photopolymer materials including nanoparticles to form gratings having periods of less than ˜500 nm. In further embodiments, the gratings have periods of ˜300-500 nm. In a number of embodiments, the type of monomers and nanoparticles can be selected to provide a high rate of diffusion during the exposure process of the grating formation. A high rate of diffusion can facilitate the formation of gratings with small period sizes. In many embodiments, the gratings are formed to have rolled K-vectors—i.e., the K-vectors of the gratings vary while maintaining a similar period. In addition to different periods and varying K-vectors, the gratings can also be formed to have a specific thickness, which is typically defined by the thickness of the layer of photopolymer material. As can readily be appreciated, the thickness at which the gratings are formed can depend on the specific application. Thinner gratings may result in lower diffraction efficiencies but higher operating angular bandwidth. In contrast to other material systems, photopolymer material systems in accordance with various embodiments of the invention are capable of providing thin gratings with sufficient diffraction efficiency values for many desired waveguide applications. In many embodiments, the gratings are formed to have a thickness of less than ˜5 μm. In further embodiments, the gratings are formed to have a thickness of ˜1-3 μm. In several embodiments, the gratings have a varying thickness profile.

The type of components utilized can depend on the specific requirements of a given application. For example, the type of nanoparticles can be selected to have low reactivity with the remaining components (e.g., the nanoparticles may be chosen for their non-reactivity to the monomers, dyes, coinitiators, etc. in the material system). In a number of embodiments, zirconium dioxide nanoparticles are utilized. In many applications, waveguide efficiency may be of critical importance. In such cases, a nanoparticle having low-absorptive properties can be advantageous. Given the amount of grating interactions within a typical waveguide application, even absorption values considered low in conventional systems can still result in an unacceptable loss of efficiency. For example, typical metallic nanoparticles having high absorptive properties would likely be undesirable for many waveguide applications. As such, in many embodiments, the type of nanoparticles is selected to provide less than 0.1% absorption. In some embodiments, the nanoparticles are non-metallic. In addition to low absorptive values, other characteristics affecting waveguide performance and grating-formation can also be considered.

In some embodiments, the nanoparticles may be a metal such as Pt, Au, and/or Ag. In some embodiments, the metal may be a metal oxide such as ZrO₂, TiO₂, WO₃, ZnO, Co₃O₄, CuO, and/or NiO.

In some embodiments, nanoparticles may include piezoelectric materials. The mechanical deformation of the grating structure of an EBG can provide a direct piezoelectric effect. In some embodiments, the piezoelectric effect may convert mechanical stress of piezoelectric material into electrical energy. Gratings including nanoparticles including piezoelectric material may have application in various sensors. Piezoelectric nanoparticles could also be used in an EBG structure for converting electrical energy into mechanical deformation (e.g. the inverse piezoelectric effect). A grating including piezoelectric nanoparticles utilizing the inverse piezoelectric effect may have applications in MEMS (e.g. optical scanners). In some embodiments, the grating with piezoelectric properties may include electrically variable grating pitch, depth and slant angle. In some embodiments, the piezoelectric materials may include PZT (lead zirconate titanate), barium titanate and lithium niobate.

In some embodiments, the shape of nanoparticles (e.g. spheres, rods, etc.) can be used to improve overall diffraction efficiency. In some embodiments, shape may have a more significant effect than the average size of the nanoparticle. In the case of nanoparticles in rod shape, the orientations of the nanoparticles are often random. In some embodiments, the nanoparticles may be in a certain alignment which can offer benefits when used in systems containing LC. In some cases the aligned nanoparticles may assist with aligning LC directors, with benefits in terms of diffraction efficiency, polarization control and electro optical performance. In some embodiments, alignment of metallic nanoparticles can be achieved using magnetic fields.

As described above, gratings with small period sizes can be advantageous in many waveguide applications. Compared to traditional HPDLC material systems, phase-separated nanoparticle-based photopolymer material can allow for the formation of gratings with a much higher resolution due to the relatively small size of nanoparticles compared to LC droplets. In typical HPDLC material systems, the LC droplets may be about 100 nm in size. This can lead to certain limitations in some applications. For instance, many waveguide applications implement a holographic exposure/recording process for forming gratings within a waveguide. Depending on the application, the resolution of feature sizes of the master grating can be limited. In several embodiments, the master grating may have about ˜125 nm resolution. As such, forming gratings using 100 nm LC droplets can be difficult and leaves little margin for error. Contrasted with photopolymer material systems described herein, the nanoparticles that form the gratings are at least an order of magnitude smaller than the LC droplets.

In some embodiments, the material system includes nanoparticles that have diameters of less than 15 nm. In further embodiments, the nanoparticles have diameters of ˜4-˜10 nm. The relatively small sizes of the nanoparticles in comparison with the resolution of the feature sizes of the master grating allow for the formation of gratings with high fidelity. Furthermore, the physical characteristics of the nanoparticles can allow for the formation of gratings that result in relatively low haze compared to the large liquid crystal droplet sizes of traditional HPDLC material systems. In several embodiments, haze of less than ˜1% can be achieved. In further embodiments, the system has haze of less than ˜0.5%.

Another important characteristic to consider in the selection of the type of nanoparticles to be used includes their refractive indices. In many applications, such as waveguide displays, the refractive indices of the components and materials can have a large effect on waveguide performance and efficiency. For example, the refractive indices of the components within a grating can determine its diffraction efficiency. In some embodiments, nanoparticles having a high refractive index n may be utilized to form gratings having high diffraction efficiencies. For example, in a number of embodiments, ZrO₂ nanoparticles having a refractive index of at least 1.7 are utilized. In some embodiments, nanoparticles having refractive indices of at least 1.9 are utilized. In further embodiments, nanoparticles having refractive indices of at least 2.1 or higher are utilized. The nanoparticles and monomers within the photopolymer mixture may be chosen to provide gratings having a high Δn. In several embodiments, the gratings have refractive index modulations of at least ˜0.04 Δn. In further embodiments, gratings having refractive index modulations of ˜0.05-0.06 Δn are utilized. Such materials can be advantageous in enabling the formation of thin gratings having sufficient diffraction efficiencies for certain waveguide applications. In a number of embodiments, the materials can form ˜2 μm-thick gratings having diffraction efficiencies of above 30%. In further embodiments, the gratings can have diffraction efficiencies of above 40%. In certain cases, metallic nanoparticles can be implemented to provide a high refractive index, a typically characteristic of metallic components. However, as discussed above, metallic components typically have high absorption and are unsuitable for use in many different waveguide applications. As such, many embodiments of the invention are directed towards material systems having non-metallic nanoparticles that are capable of forming thin, efficient gratings.

### Applications Utilizing Nanoparticle-Based Photopolymer Materials

Nanoparticle-based photopolymer materials in accordance with various embodiments of the invention can be implemented for many different applications. As described above, such materials can be implemented to form isotropic gratings for use in waveguide displays. Waveguides implementing isotropic gratings can be designed to reduce or eliminate polarization rotation effects, which effectively reduces or eliminate defects such as striations and other artefacts. In many embodiments, a waveguide incorporating at least one input coupler, at least one fold grating, and at least one output grating. Input couplers such as but not limited to prisms and input gratings can be utilized. In some embodiments, the waveguide includes an anisotropic input grating and an isotropic fold grating. Waveguides implementing different configurations of isotropic and anisotropic gratings can be formed and manufactured in a number of different ways. In a number of embodiments, the waveguide is formed by utilizing a deposition process, such as but not limited to inkjet printing, to form a waveguide cell. Each of the areas designated for the gratings can be deposited with the appropriate material for forming the desired grating structure. For example, to form an anisotropic input grating, an HPDLC material can be deposited over the area designated for the input grating. After holographic exposure, the HPDLC material can form an SBG grating. Similarly, nanoparticle-based photopolymer materials can be deposited over the area designated for the fold grating to form an isotropic fold grating after holographic exposure. In several embodiments, monomers are deposited over the non-grating areas. As can readily be appreciated, waveguides incorporating anisotropic/isotropic gratings can be formed in a number of different ways. In a number of embodiments, vacuum filling processes are implemented for forming the appropriate waveguide cells for forming such waveguides. Multi-material vacuum filling processes can be implemented on empty waveguide cells with areas sectioned off for the various gratings.

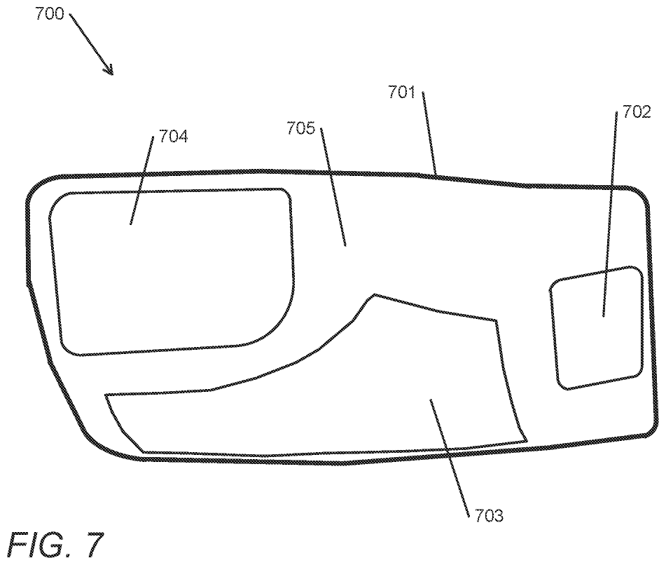

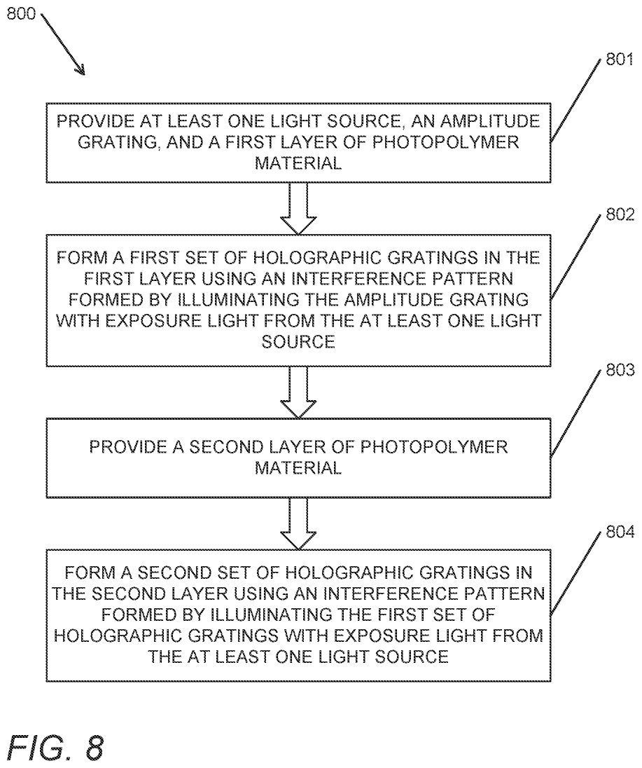

FIG. 7 conceptually illustrates a waveguide cell with defined grating areas containing different materials in accordance with an embodiment of the invention. FIG. 7 shows a plan view of a waveguide cell 700 containing marked areas for an input grating 702, a fold grating 703, and an output grating 704. The remaining areas are non-grating areas 705. As described above, the waveguide cell 700 can be constructed to have different materials deposited in different areas. For example, in many embodiments, the non-grating areas 705 contain only monomers as diffractions are not intended to occur in such areas. By depositing only monomers in those areas, those areas will contribute minimal haze to the system. The grating areas 702-704 can include various materials depending on the application. In some embodiments, the input grating area 702 includes HPDLC materials for forming gratings having high P-polarization response. Such structures can be utilized to provide a high amount of in-coupled light. In several embodiments, the fold grating area 703 includes nanoparticle-based photopolymer materials for forming isotropic gratings. As described above, such gratings can provide higher uniformity for the waveguide.

Isotropic/anisotropic grating structures can be implemented in many different waveguide display applications. In many embodiments, a near-eye waveguide display having at least one isotropic grating is implemented. In further embodiments, the near-eye display includes at least one anisotropic grating. Waveguides implementing both isotropic and anisotropic gratings can be configured in many different ways. In several embodiments, the grating layer may be approximately ˜2-3 μm thick. In some embodiments, the waveguide includes multiplexed gratings. In further embodiments, the multiplexed gratings are isotropic gratings, which can be formed using nanoparticle-based photopolymer materials. In a number of embodiments, the multiplexed gratings are implemented as integrated gratings, such as those described in the sections above. As can readily be appreciated, the specific grating architecture can depend on the requirements of a given application. For example, in various embodiments, the waveguide includes an anisotropic input grating and an isotropic fold grating in order to provide high input coupling efficiency while reducing the appearances of defects and/or artifacts. Anisotropic gratings can often include high diffraction efficiency values for polarized light. For instance, SBGs formed of HPDLC materials often have high diffraction efficiencies for P-polarized light. As such, a number of embodiments includes the use of polarized light and an anisotropic input grating to provide higher input coupling efficiencies. In several embodiments, the input light is a laser optical engine. In many embodiments, the waveguide includes an input coupler and integrated multiplexed gratings providing the functions of both typical fold and output gratings. In further embodiments, the input coupler is an anisotropic input grating and the integrated gratings are isotropic gratings.

In addition to near-eye waveguide display applications, nanoparticle-based photopolymer materials can also be advantageously implemented in vehicular and automotive waveguide display applications. Typically, automotive heads-up display systems implementing waveguide displays are relatively large in size. For example, waveguides having lengths of at least 300 mm are typically utilized. In many cases, the optical propagation path within the waveguide is at least 600 mm. Large gratings often translate to longer light paths and TIR bounces within the waveguide, which can present difficulties in providing light uniformity and controlling haze. As described above, nanoparticle-based photopolymer can be implemented to form waveguides with improved uniformity and haze compared to traditional systems. In many embodiments, the automotive waveguide includes at least one input coupler, at least one fold grating, and at least one output grating. The input coupler can be implemented in various ways, including but not limited to the use of input prisms and input gratings. In some embodiments, the fold grating is formed using nanoparticle-based photopolymer materials. In a number of embodiments, the fold grating is an isotropic grating. In several embodiments, the input and/or output gratings are also formed using nanoparticle-based photopolymer materials and are also isotropic gratings. As described above, isotropic gratings can reduce or eliminate polarization rotation effects to provide better uniformity. As can readily be appreciated, various grating architectures and configurations can be implemented. In various embodiments, the input grating may be an anisotropic grating, which can be implemented to provide higher input coupling efficiency. In automotive heads-up display applications, the type of polarization coupled out of the system can be important. In a number of applications, it may be desirable for the output light to be P-polarized. In such cases, the system is typically oriented such that the light would provide S-polarized light with respect to the windshield. To provide high amounts of P-polarized output light, the waveguide can efficiently include an anisotropic output grating, which can be an SBG formed of HPDLC materials. In a number of embodiments, the output grating may be an isotropic grating. In such cases, the windshield can be configured to incorporate a polarized film or coating for reflecting P-polarized light.

In addition to gratings for use in waveguide displays, nanoparticle-based photopolymer materials in accordance with various embodiments of the invention can be implemented to form gratings for use as a master grating in holographic recording systems. In typical holographic exposure processes, a master grating is used to form the desired pattern of light for exposure of uncured photopolymer materials. In many cases, the master grating is an amplitude grating, such as but not limited to a chrome grating. However, chrome gratings can be prohibitively expensive for implementation in some applications. For example, in high volume manufacturing systems, multiple chrome gratings may be required. In several applications, large chrome masters, the costs of which scale exponentially with the increase in size, may be used. Another issue is that chrome gratings typically provide low diffraction efficiencies, effectively increasing the required power of the original exposure beam. In many embodiments, a holographic grating can be implemented as the master grating. Traditional holographic gratings can provide greater diffraction efficiency values compared to traditional amplitude gratings but can be difficult to implement due to high haze values, which adversely affect the recorded gratings and are unacceptable in typical waveguide applications. On the other hand, holographic gratings formed from nanoparticle-based photopolymer materials can produce haze at a low enough level sufficient for serving as a master grating for holographic exposure processes. Furthermore, the costs of fabricating such photopolymer holographic gratings can be negligible compared to chrome masters in many applications. In some embodiments, the holographic master grating formed from nanoparticle-based photopolymer materials provides little to no reflection for incident beams. This can be advantageous in many recording processes as undesired exposure resulting from reflected rays can be mitigated or avoided. In several embodiments, the recording process implemented utilizes S-polarized exposure light. In such cases, holographic master gratings formed from nanoparticle-based photopolymer materials can be suitable for such processes due to their high diffraction efficiencies for S-polarized light as compared to conventional holographic gratings. As can readily be appreciated, master gratings formed from nanoparticle-based photopolymer materials can be designed and configured in a number of different ways depending on the specific holographic recording process. In many embodiments, the holographic master grating includes a grating layer sandwiched between two transparent substrates. The grating layer can be formed of specific thicknesses, which can provide certain desirable performance such as but not limited to higher diffraction efficiencies. In some embodiments, the grating layer is at least ˜3 μm thick. In several embodiments, the grating layer is at least ˜5 μm thick. In further embodiments, the grating layer is at least ˜5 μm thick and provides diffraction efficiencies of at least ˜40% for the angles used in the recording process. The specific thickness utilized can depend on the specific application and certain trade-offs can be considered. For example, thinner gratings can provide less haze while thicker gratings provide higher diffraction efficiencies.

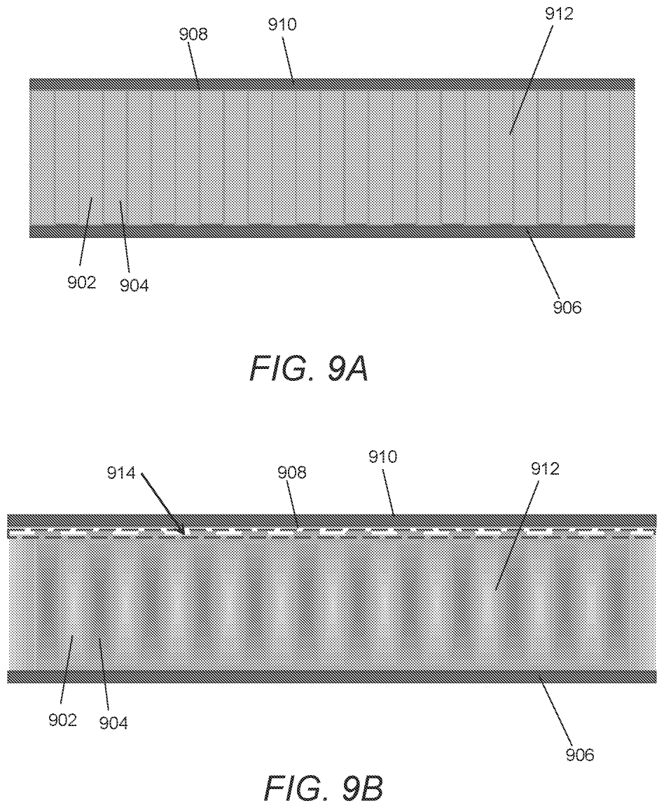

FIG. 8 is a flow chart conceptually illustrating a process for forming gratings using a holographic master grating in accordance with an embodiment of the invention. As shown, the process 800 includes providing (801) at least one light source, an amplitude grating, and a first layer of photopolymer material. Various types of components and materials can be utilized. In many embodiments, the amplitude grating is a chrome master. In some embodiments, the first layer of photopolymer material includes nanoparticle-based photopolymer materials. A first set of holographic gratings can be formed (802) in the first layer of photopolymer material by illuminating the amplitude grating with exposure light from the at least one light source to expose the first layer of photopolymer material with an interference pattern. Different exposure processes, including but not limited to single-beam and dual-beam interferential exposure, can be utilized. A second layer of photopolymer material can be provided (803). In a number of embodiments, the second layer of photopolymer material includes nanoparticle-based photopolymer materials. In several embodiments, the second layer of photopolymer material includes HPDLC materials. As can readily be appreciated, any type of photopolymer materials can be utilized as appropriate depending on the specific requirements of a given application. A second set of holographic gratings can be formed (804) in the second layer of photopolymer material by illuminating the first set of holographic gratings with exposure light from the at least one light source to expose the second layer of photopolymer material with an interference pattern. Different types of gratings, including but not limited to holographic gratings, RKV gratings, integrated gratings, multiplexed gratings, and any other grating structures including those described in this disclosure herein, can be formed.

Although FIG. 8 illustrates a specific method of forming gratings using a holographic master grating, many different processes can be implemented as appropriate depending on the specific requirements of a given application. In many embodiments, a single-beam interferential exposure process is implemented for forming the holographic gratings. In some embodiments, two light sources are used for providing interferential exposure. As can readily be appreciated, different types of light sources can be utilized, the specific type of which can depend on the photopolymer material. In several embodiments, the light source is configured to emit light of around ˜450-650 nm. In some embodiments, the light source emits light with a wavelength of 532 nm. In a number of embodiments, the light source is configured to emit S-polarized light. In further embodiments, the light source includes various polarization manipulation structures and plates for providing S-polarized light. As can readily be appreciated, light sources of various polarizations and wavelengths can be implemented as appropriate depending on the application.

### Embodiments Including Ashing

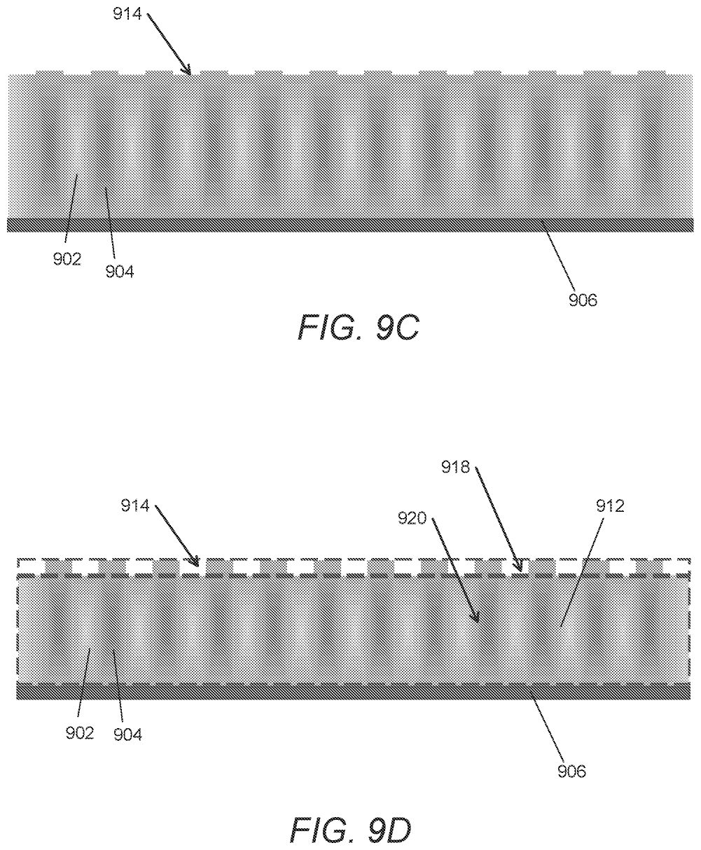

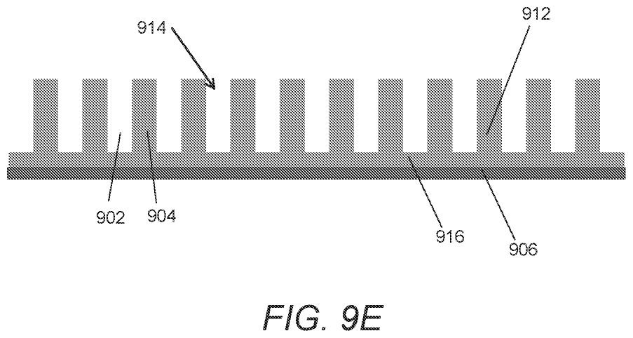

In some embodiments, an additional ashing step may be performed. FIGS. 9A-9E illustrates a process of forming a grating using holographic photopolymer materials including nanoparticles in accordance with an embodiment of the invention. FIG. 9A illustrates a starting layer of holographic photopolymer material including nanoparticles encapsulated into an unexposed cell. The unexposed cell includes a layer 912 of holographic photopolymer material including nanoparticles is included on a bottom substrate 906. The layer 912 may include bright fringe regions 902 and dark fringe regions 904. The layer 912 may be sandwiched between the bottom substrate 906 and a top substrate 910. The top substrate 910 may be removed from the layer 912. A release layer 908 may be coated on the top substrate 910. The release layer 908 may allow the top substrate 910 to be removable. The release layer 908 may be a silane based fluoropolymer or fluoro monomer reactant. The release layer 908 may include a fluoropolymer such as OPTOOL UD509 (produced by Daikin Chemicals), Dow Corning 2634, Fluoropel (produced by Cytonix), and EC200 (produced by PPG Industries, Inc) or a fluoro monomer. The release layer 908 may be applied through vapor deposition, spin coating, or spraying. In some embodiments, the top substrate 910 may be reusable and thus after removal after holographic exposure, the top substrate 910 may be placed on another holographic mixture layer which may be exposed with holographic beams.

FIG. 9B illustrates the cell of FIG. 9A after it has been exposed to a holographic recording beam. As illustrated, the nanoparticles diffuse into the dark fringe regions 904 to create nanoparticle rich regions in the dark fringe regions 904 and nanoparticle poor regions in the light fringe regions 902. The top of the layer 912 includes a thin surface topology 914 after exposure.

FIG. 9C illustrates the cell of FIG. 9B after the top substrate 910 has been removed. As discussed in connection with FIG. 9A, the release layer 908 may aid in the removal of the top substrate 910 from the layer 912.

FIG. 9D illustrates the cell of FIG. 9C after an ashing step is conducted. The ashing step may be a plasma etch which may remove the nanoparticle poor regions while keeping the nanoparticle rich regions. In some embodiments, the ashing step may etch the nanoparticle rich regions at a lesser rate than the nanoparticle poor regions. The depth of the surface topology 914 of the layer 912 may increase due to the ashing. The surface topology 914 may form a surface relief grating 918 on top of a volume grating 920.

FIG. 9E illustrates the cell of FIG. 9D after continued ashing is conducted. The surface topology 914 of the layer 912 may continue to increase creating deep inorganic surface relief gratings with high aspect ratios. A bias layer 916 may be present depending on the nanoparticle functionality of concentration of the starting layer 912.

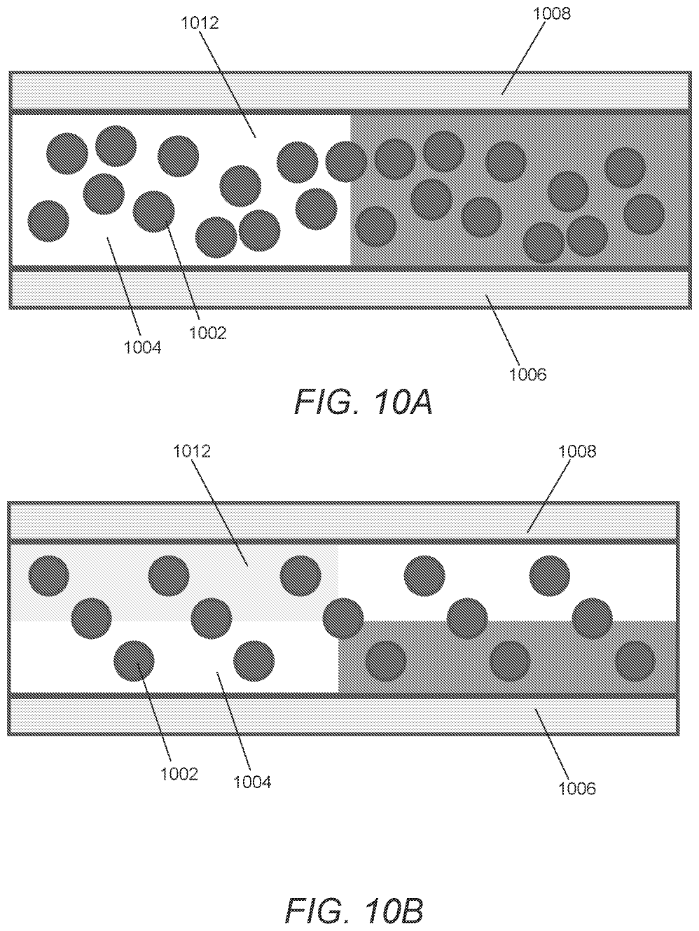

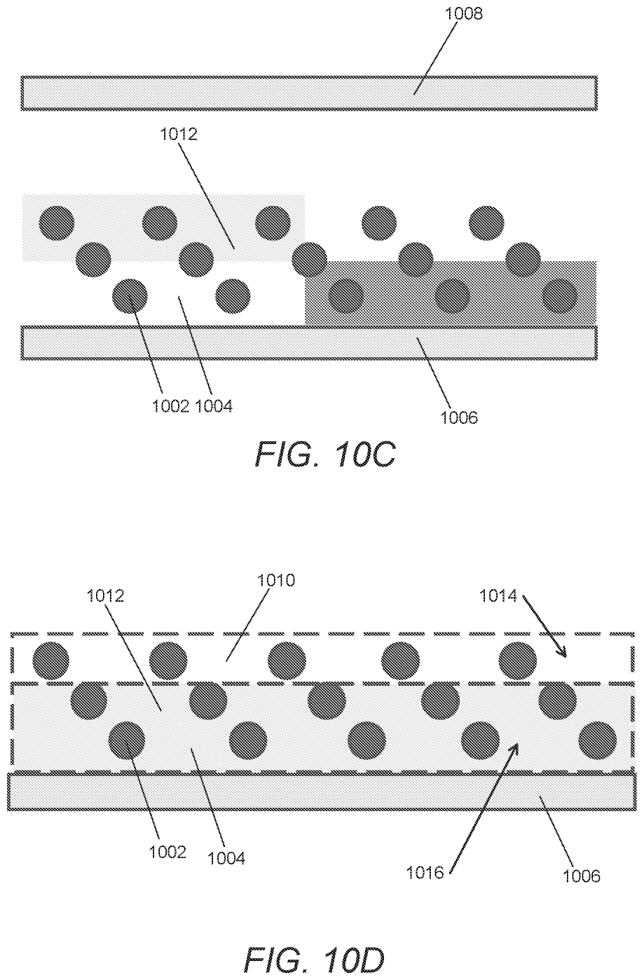

FIGS. 10A-10D illustrates a process forming a grating using holographic photopolymer materials including nanoparticles in accordance with an embodiment of the invention. FIG. 10A illustrates a starting cell including a holographic layer 1012 of photopolymer material 1004 combined with nanoparticles 1002. The holographic layer 1012 is sandwiched between a bottom substrate 1006 and a top substrate 1008.

FIG. 10B illustrates the starting cell of FIG. 10A after holographic exposure. As illustrated, the nanoparticles 1002 diffuse into linear regions creating alternating nanoparticle rich regions and nanoparticle poor (polymer rich) regions.

FIG. 10C illustrates the cell of FIG. 10B after the top substrate 1008 is removed. As discussed previously, the top substrate 1008 may include a release layer which may aid in the removal of the top substrate 1008 from the holographic layer 1012. FIG. 10D illustrates the holographic layer 1012 of FIG. 10C after ashing. The ashing creates holes 1010 in the top surface of the holographic layer 1012. The ashing may be a plasma etch which may etch the nanoparticle poor regions faster than the nanoparticle rich regions creating the holes 1010. After ashing, a surface relief grating 1014 may be formed on top of a volume grating 1016.

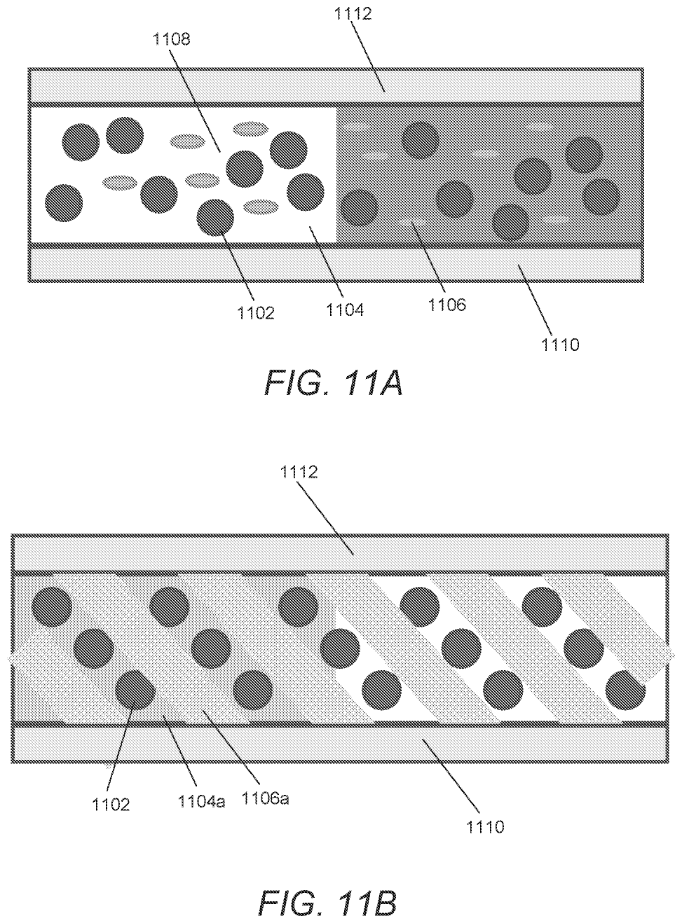

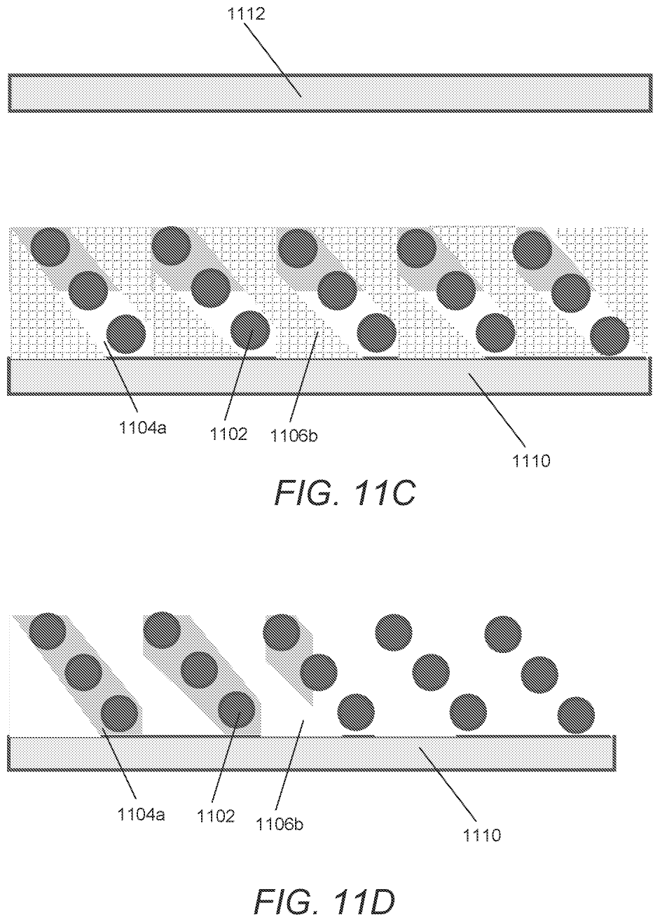

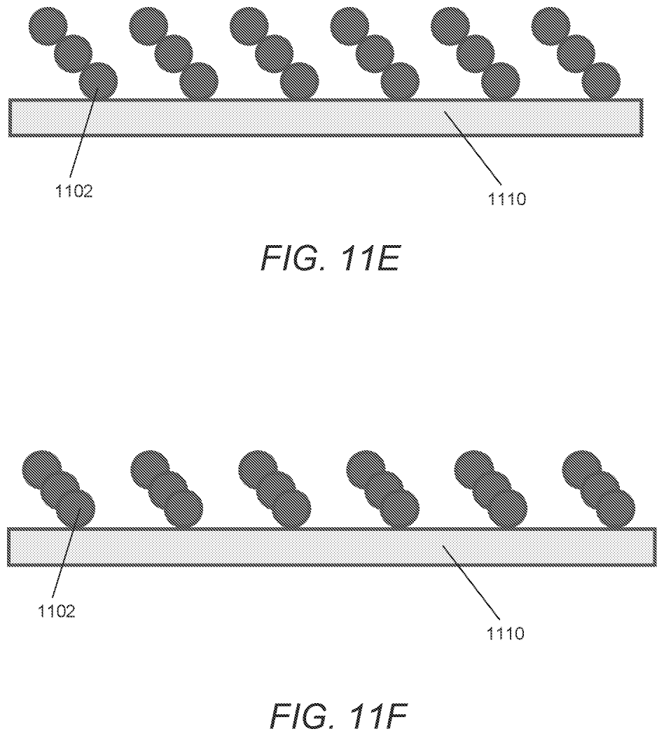

FIGS. 11A-11F illustrate a process of forming a grating using holographic photopolymer materials including nanoparticles and an inert liquid in accordance with an embodiment of the invention. FIG. 11A illustrates a starting cell including a holographic layer 1108 of nanoparticles 1102, monomer mixture 1104, and inert liquid 1106. The inert liquid 1106 may be a liquid crystal. The holographic layer 1108 may be sandwiched between a bottom substrate 1110 and a top substrate 1112 such that the nanoparticles 1102, monomer mixture 1104, and inert liquid 1106 may be randomly distributed. The inert liquid 1106 may form droplets within the monomer mixture 1104. The nanoparticles 1102 may include capping agents that may react with the monomer mixture 1104.

FIG. 11B illustrates the starting cell of FIG. 11A after holographic exposure. The holographic exposure may be an interference pattern which causes polymerization of the monomer mixture 1104 to form a polymer network 1104a which binds the nanoparticles 1102. The inert liquid 1106 may diffuse into the dark fringes of the holographic exposure to form stripes 1106a of inert liquid 1106.

FIG. 11C illustrates the cell of FIG. 11B after the top substrate 1112 has been removed. The top substrate 1112 may be coated with a release layer which may aid with removal of the top substrate 1112 from the holographic layer 1108. After the top substrate 1112 is removed, the stripes 1106a of inert liquid 1106 may be removed or evacuated from the holographic layer 1108 to form air pockets 1106b. The inert liquid 1106 may be removed through washing with a solvent such as alcohol. After the inert liquid 1106 has been removed, loose polymer networks may remain between the stripes of nanoparticles 1102 embedded in polymer networks 1104a.

FIG. 11D illustrates the cell of FIG. 11C after a preliminary ashing step. The ashing step may remove the loose polymer networks which remain between the stripes of nanoparticles 1102 embedded in polymer networks 1104a. FIG. 11E illustrates the cell of FIG. 11D after further ashing which completely removes the polymer networks 1104a leaving just the nanoparticles 1102 which creates an inorganic grating structure. FIG. 11F illustrate the cell of FIG. 11E after a sintering step which removes grain boundaries between the nanoparticles 1102 and thus solidifies the inorganic grating structure.

While the steps of FIG. 11A-11F are discussed as a series of steps, only a subset of the steps may be performed in order to create various gratings. For example, the step described in connection with FIG. 11F may be omitted and thus the resultant grating may be the grating discussed in connection with FIG. 11E. Also, the steps described in connection with FIGS. 11E and 11F may be omitted and thus the resultant grating may be the grating discussed in connection with FIG. 11D. Similarly, the steps described in connection with FIGS. 11D-11F may be omitted and thus the resultant grating may be the grating discussed in connection with FIG. 11C.

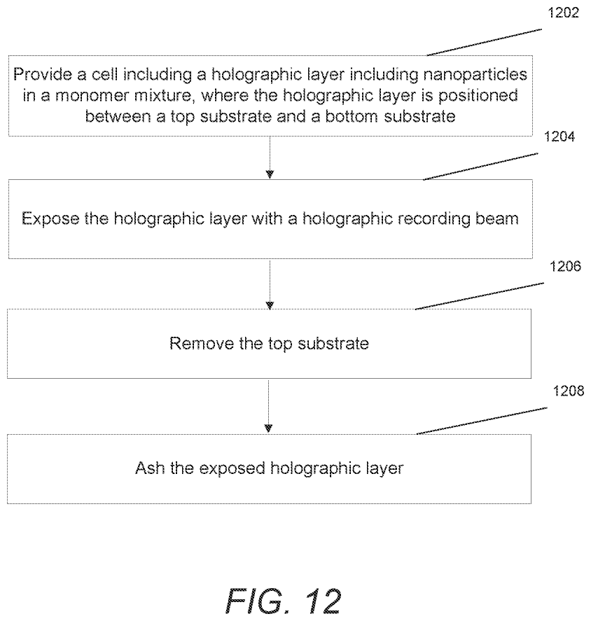

FIG. 12 illustrates a process for producing a grating in accordance with an embodiment of the invention. This process mirrors the process illustrated in FIGS. 9A-9E and FIGS. 10A-10D. The process includes providing (1202) a cell including a layer of holographic recording material including a mixture comprising at least one nanoparticle and at least one monomer, where the layer of holographic recording material is positioned between a top substrate and a bottom substrate. The layer of holographic recording material then is exposed (1204) with crossed holographic recording beams. The holographic recording beams interfere to form dark fringe regions and light fringe regions. The nanoparticles diffuse to the dark fringe regions (while polymerization of the monomer takes place) creating nanoparticle rich regions separated by nanoparticle poor (polymer rich) regions. The top substrate may be removed (1206) which exposes the exposed layer of holographic recording material. The exposed layer of holographic recording material may be ashed (1208) which may plasma etch the nanoparticle poor regions at a higher rate than the nanoparticle rich regions. This may create a surface relief grating on top of a volume grating.

### Multi-Layered Waveguide Fabrication

Waveguide manufacturing in accordance with various embodiments of the invention can be implemented for the fabrication of multi-layered waveguides. Multi-layered waveguides refer to a class of waveguides that utilizes two or more layers having gratings or other optical structures. Although the discussions below may pertain to gratings, any type of holographic optical structure can be implemented and substituted as appropriate. Multi-layered waveguides can be implemented for various purposes, including but not limited to improving spectral and/or angular bandwidths. Traditionally, multi-layered waveguides are formed by stacking and aligning waveguides having a single grating layer. In such cases, each grating layer is typically bounded by a pair of transparent substrates. To maintain the desired total internal reflection characteristics, the waveguides are usually stacked using spacers to form air gaps between the individual waveguides.

In contrast to traditional stacked waveguides, many embodiments of the invention are directed to the manufacturing of multi-layered waveguides having alternating substrate layers and grating layers. Such waveguides can be fabricated with an iterative process capable of sequentially forming grating layers for a single waveguide. In several embodiments, the multi-layered waveguide is fabricated with two grating layers. In a number of embodiments, the multi-layered waveguide is fabricated with three grating layers. Any number of grating layers can be formed, limited by the tools utilized and/or waveguide design. Compared to traditional multi-layered waveguides, this allows for a reduction in thickness, materials, and costs as fewer substrates are needed. Furthermore, the manufacturing process for such waveguides allow for a higher yield in production due to simplified alignment and substrate matching requirements.

Manufacturing processes for multi-layered waveguides having alternating transparent substrate layers and grating layers in accordance with various embodiments of the invention can be implemented using a variety of techniques. In many embodiments, the manufacturing process includes depositing a first layer of optical recording material onto a first transparent substrate. Optical recording material can include various materials and mixtures, including but not limited to HPDLC mixtures and any of the material formulations discussed in the sections above. Similarly, any of a variety of deposition techniques, such as but not limited to spraying, spin coating, inkjet printing, and any of the techniques described in the sections above, can be utilized. Transparent substrates of various shapes, thicknesses, and materials can be utilized. Transparent substrates can include but are not limited to glass substrates and plastic substrates. Depending on the application, the transparent substrates can be coated with different types of films for various purposes. Once the deposition process is completed, a second transparent substrate can then be placed onto the deposited first layer of optical recording material. In some embodiments, the process includes a lamination step to form the three-layer composite into a desired height/thickness. An exposure process can be implemented to form a set of gratings within the first layer of optical recording material. Exposure processes, such as but not limited to single-beam interferential exposure and any of the other exposure processes described in the sections above, can be utilized. In essence, a single-layered waveguide is now formed. The process can then repeat to add on additional layers to the waveguide. In several embodiments, a second layer of optical recording material is deposited onto the second transparent substrate. A third transparent substrate can be placed onto the second layer of optical recording material. Similar to the previous steps, the composite can be laminated to a desired height/thickness. A second exposure process can then be performed to form a set of gratings within the second layer of optical recording material. The result is a waveguide having two grating layers. As can readily be appreciated, the process can continue iteratively to add additional layers. The additional optical recording layers can be added onto either side of the current laminate. For instance, a third layer of optical recording material can be deposited onto the outer surface of either the first transparent substrate or the third transparent substrate.

In many embodiments, the manufacturing process includes one or more post processing steps. Post processing steps such as but not limited to planarization, cleaning, application of protective coats, thermal annealing, alignment of LC directors to achieve a desired birefringence state, extraction of LC from recorded SBGs and refilling with another material, etc. can be carried out at any stage of the manufacturing process. Some processes such as but not limited to waveguide dicing (where multiple elements are being produced), edge finishing, AR coating deposition, final protective coating application, etc. are typically carried out at the end of the manufacturing process.

In many embodiments, spacers, such as but not limited to beads and other particles, are dispersed throughout the optical recording material to help control and maintain the thickness of the layer of optical recording material. The spacers can also help prevent the two substrates from collapsing onto one another. In some embodiments, the waveguide cell is constructed with an optical recording layer sandwiched between two planar substrates. Depending on the type of optical recording material used, thickness control can be difficult to achieve due to the viscosity of some optical recording materials and the lack of a bounding perimeter for the optical recording layer. In a number of embodiments, the spacers are relatively incompressible solids, which can allow for the construction of waveguide cells with consistent thicknesses. The spacers can take any suitable geometry, including but not limited to rods and spheres. The size of a spacer can determine a localized minimum thickness for the area around the individual spacer. As such, the dimensions of the spacers can be selected to help attain the desired optical recording layer thickness. The spacers can take any suitable size. In many cases, the sizes of the spacers range from 1 to 30 μm. The spacers can be made of any of a variety of materials, including but not limited to plastics (e.g., divinylbenzene), silica, microspheres, photoresist materials (e.g. SU-8), and conductive materials. In several embodiments, the material of the spacers is selected such that its refractive index does not substantially affect the propagation of light within the waveguide cell.

In many embodiments, the first layer of optical recording material is incorporated between the first and second transparent substrates using vacuum filling methods. In a number of embodiments, the layer of optical recording materials is separated in different sections, which can be filled or deposited as appropriate depending on the specific requirements of a given application. In some embodiments, the manufacturing system is configured to expose the optical recording material from below. In such embodiments, the iterative multi-layered fabrication process can include turning over the current device such that the exposure light is incident on a newly deposited optical recording layer before it is incident on any formed grating layers.

In many embodiments, the exposing process can include temporarily “erasing” or making transparent the previously formed grating layer such that they will not interfere with the recording process of the newly deposited optical recording layer. Temporarily “erased” gratings or other optical structures can behave similar to transparent materials, allowing light to pass through without affecting the ray paths. Methods for recording gratings into layers of optical recording material using such techniques can include fabricating a stack of optical structures in which a first optical recording material layer deposited on a substrate is exposed to form a first set of gratings, which can be temporarily erased so that a second set of gratings can be recorded into a second optical recording material layer using optical recording beams traversing the first optical recording material layer. Although the recording methods are discussed primarily with regards to waveguides with two grating layers, the basic principle can be applied to waveguides with more than two grating layers.

Multi-layered waveguide fabrication processes incorporating steps of temporarily erasing a grating structure can be implemented in various ways. Typically, the first layer is formed using conventional methods. The recording material utilized can include material systems capable of supporting optical structures that can be erased in response to a stimulus. In embodiments in which the optical structure is a holographic grating, the exposure process can utilize a crossed-beam holographic recording apparatus. In a number of embodiments, the optical recording process uses beams provided by a master grating, which may be a Bragg hologram recorded in a photopolymer or an amplitude grating. In some embodiments, the exposure process utilizes a single recording beam in conjunction with a master grating to form an interferential exposure beam. In addition to the processes described, other industrial processes and apparatuses currently used in the field to fabricate holograms can be used.

Once a first set of gratings is recorded, additional material layers can be added similar to the processes described above. During the exposure process of any material layer after the first material layer, an external stimulus can be applied to any previously formed gratings to render them effectively transparent. The effectively transparent grating layers can allow for light to pass through to expose the new material layer. External stimulus/stimuli can include optical, thermal, chemical, mechanical, electrical, and/or magnetic stimuli. In many embodiments, the external stimulus is applied at a strength below a predefined threshold to produce optical noise below a predefined level. The specific predefined threshold can depend on the type of material used to form the gratings. In some embodiments, a sacrificial alignment layer applied to the first material layer can be used to temporarily erase the first set of gratings. In some embodiments, the strength of the external stimulus applied to the first set of gratings is controlled to reduced optical noise in the optical device during normal operation. In several embodiments, the optical recording material further includes an additive for facilitating the process of erasing the gratings, which can include any of the methods described above. In a number of embodiments, a stimulus is applied for the restoration of an erased layer.

The clearing and restoration of a recorded layer described in the process above can be achieved using many different methods. In many embodiments, the first layer is cleared by applying a stimulus continuously during the recording of the second layer. In other embodiments, the stimulus is initially applied, and the grating in the cleared layer can naturally revert to its recorded state over a timescale that allows for the recording of the second grating. In other embodiments, the layer stays cleared after application of an external stimulus and reverts in response to another external stimulus. In several embodiments, the restoration of the first optical structure to its recorded state can be carried out using an alignment layer or an external stimulus. An external stimulus used for such restoration can be any of a variety of different stimuli, including but not limited to the stimulus/stimuli used to clear the optical structure. Depending on the composition material of the optical structure and layer to be cleared, the clearing process can vary. Further discussion regarding the multi-layered waveguide fabrication utilizing external stimuli can be found in US Pat. App. Pub. No. 2020/0033801 filed Jul. 25, 2019 entitled “Systems and Methods for Fabricating a Multilayer Optical Structure,” the disclosure of which is hereby incorporated by reference in its entirety for all purposes.

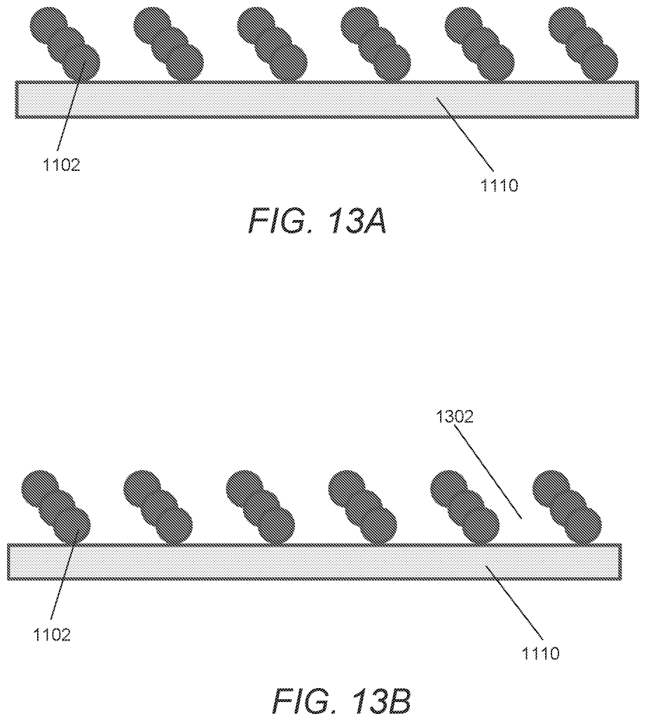

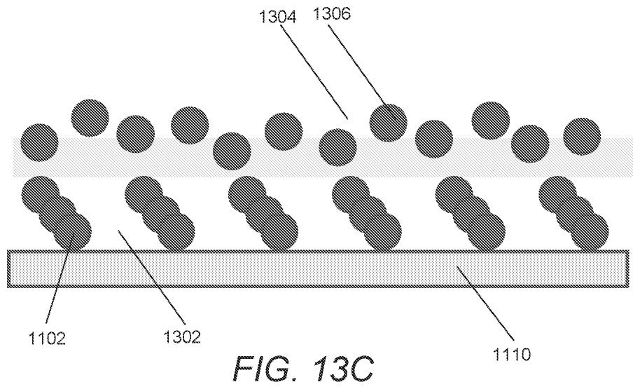

In some embodiments, the multi-layer grating may include multiple layers directly stacked upon one another. FIGS. 13A-13C conceptually illustrate a process for manufacturing multi-layer gratings in accordance with an embodiment of the invention. FIG. 13A is the grating created using the process described in FIGS. 11A-11F. The grating includes an inorganic structure which includes the sintered nanoparticles 1102. FIG. 13B illustrates a multi-layer grating in accordance with an embodiment of the invention. The grating described in connection of FIG. 13A may be coated with an additional material 1302 may be coated onto the inorganic structure. The additional material 1302 may be used to tune the average index or create other unique properties.

FIG. 13C illustrates a multi-layer grating in accordance with an embodiment of the invention. The grating of FIG. 13B may be coated with an additional layer 1304. The additional layer 1304 may have different material characteristics to the additional material 1302. There may be nanoparticles 1306 embedded within the additional layer 1304.

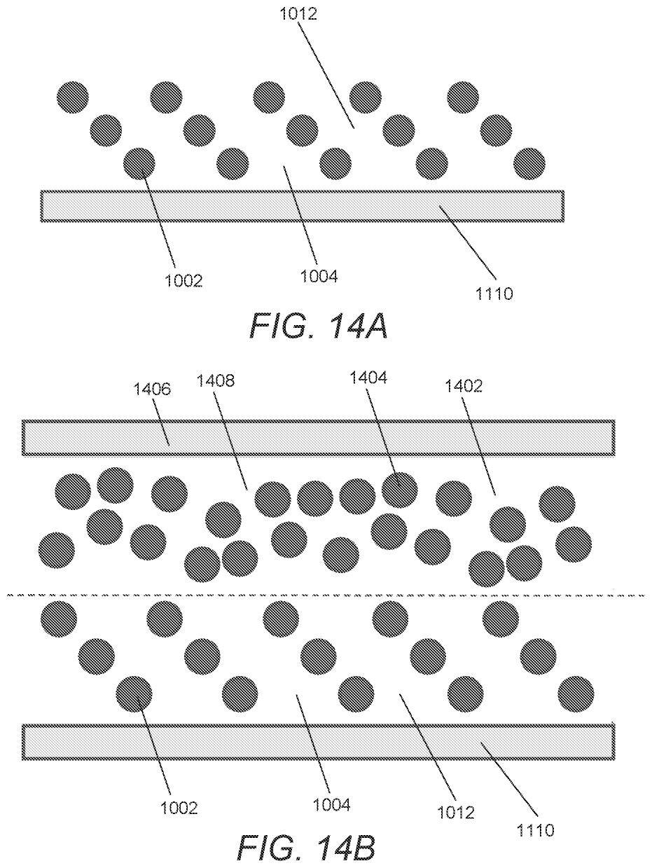

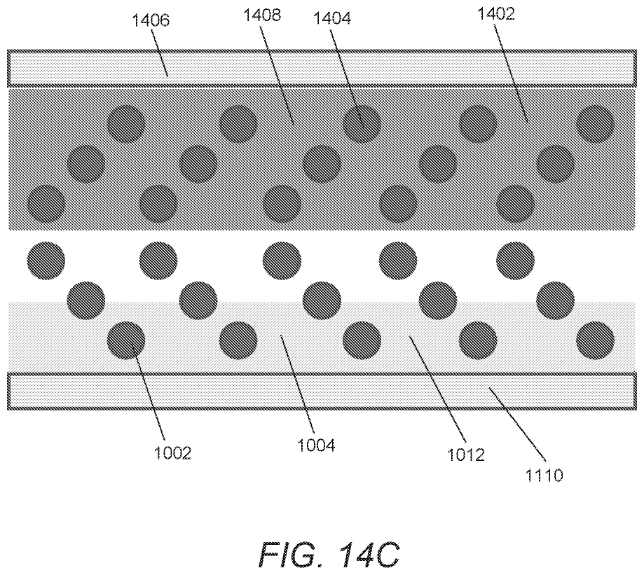

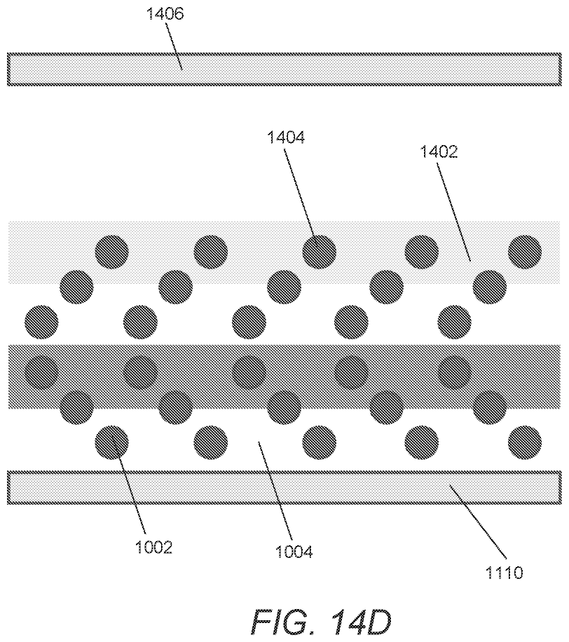

FIGS. 14A-14D conceptually illustrates a process for manufacturing multi-layer gratings in accordance with an embodiment of the invention. FIG. 14A illustrates the grating created using the process described in FIGS. 10A-10C. FIG. 14B illustrates the grating of FIG. 14A after a second holographic layer 1408 of monomer mixture 1402 combined with nanoparticles 1404 are added on top of the grating 1012. A top substrate 1406 may be placed on top of the second holographic layer 1408. The nanoparticles 1404 may be randomly distributed within the monomer mixture 1402. The nanoparticles 1404 may include capping agents that do not react with the monomer mixture 1402.

FIG. 14C illustrates the multi-layer grating of FIG. 14B after a holographic exposure of the second holographic layer 1408. The holographic exposure diffuses the nanoparticles 1404 into dark fringe regions. The nanoparticles 1404 may diffuse into slanted fringes that are of different orientation than the nanoparticles 1002 of the first holographic layer 1012. In some embodiments, the nanoparticles 1404 may diffuse into slanted fringes that are of the same orientation as the nanoparticles 1002 of the first holographic layer 1012. FIG. 14D illustrates the multi-layer grating of FIG. 14C after the removal of the top substrate 1406. In some embodiments, the process may be repeated to create a grating with more layers.

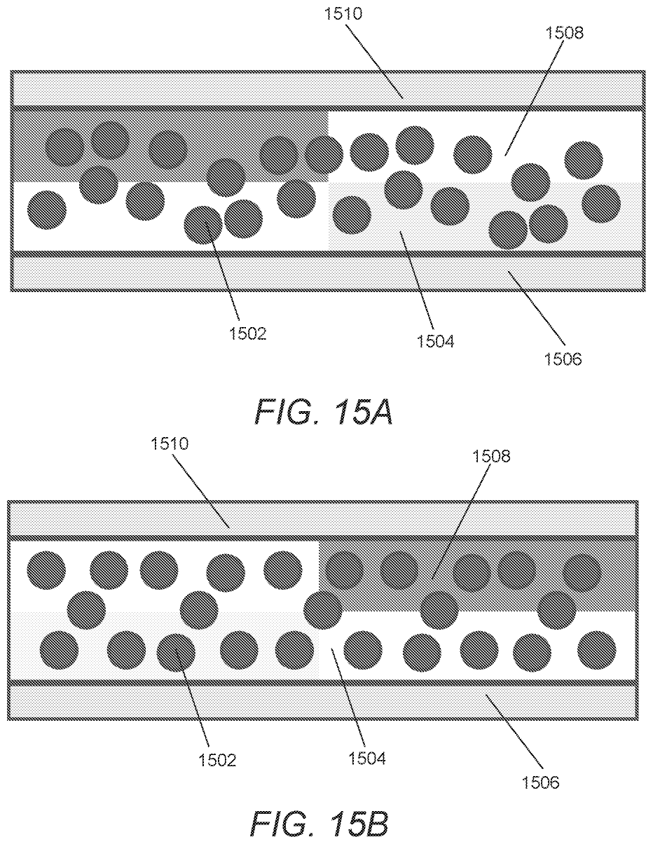

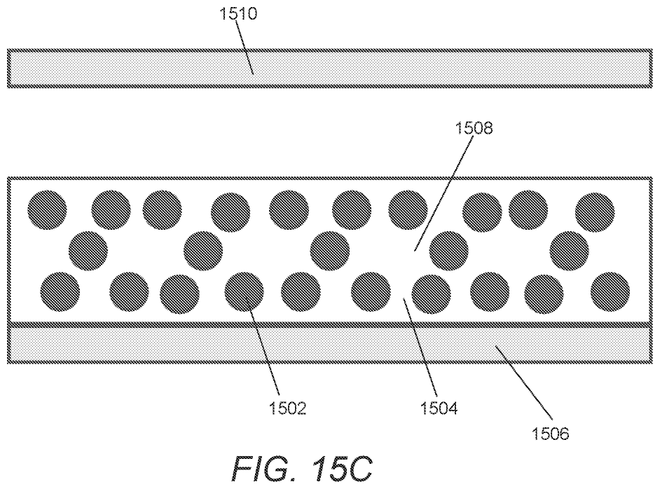

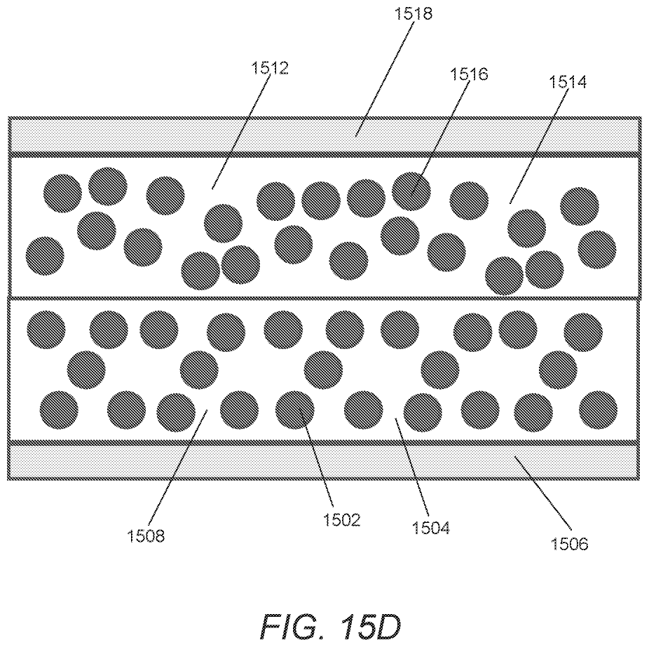

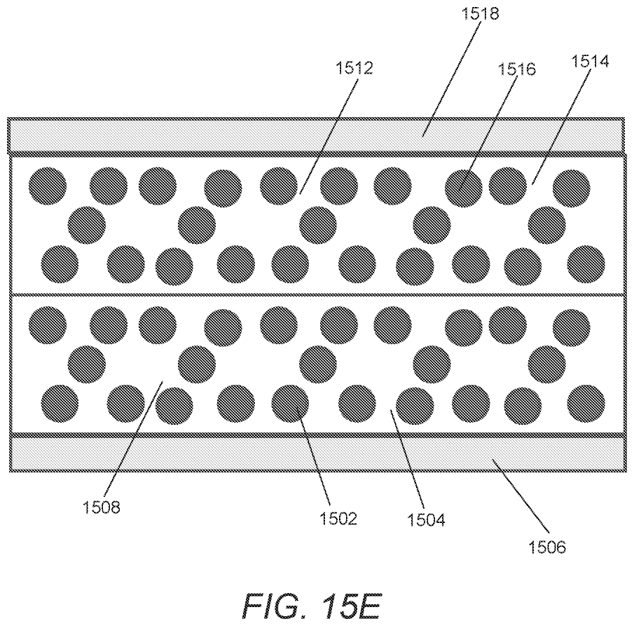

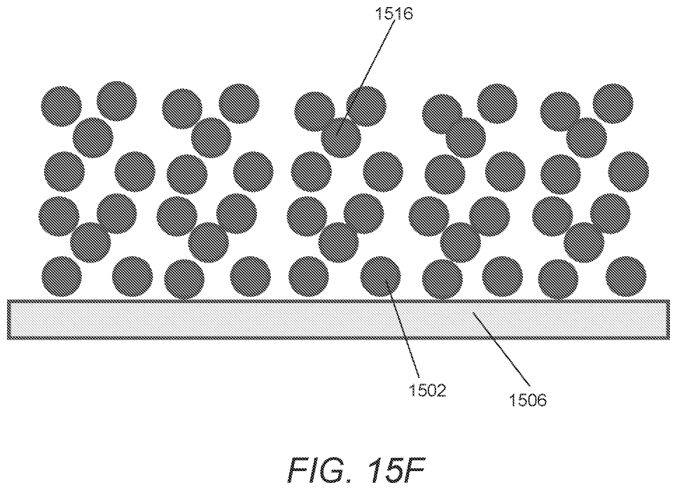

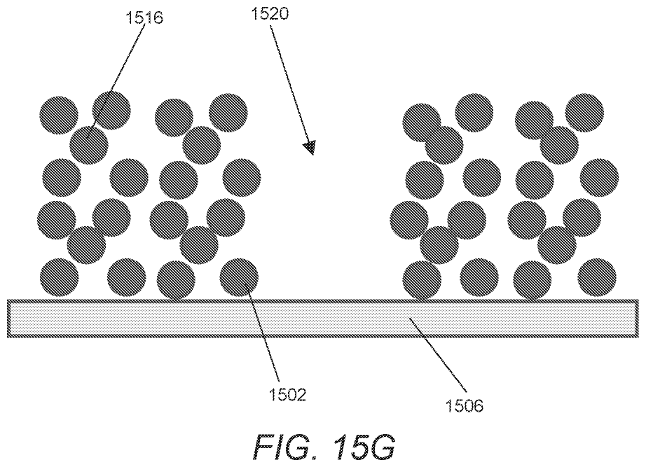

FIGS. 15A-15G illustrates a process for manufacturing a multi-layer grating in accordance with an embodiment of the invention. FIG. 15A illustrates a starting cell including a holographic layer 1508 of monomer material 1504 combined with nanoparticles 1502. The holographic layer 1508 is sandwiched between a bottom substrate 1506 and a top substrate 1510.

FIG. 15B illustrates the starting cell of FIG. 15A after exposure with a holographic recording beam. Interference patterns may cause polymerization in bright fringes. Nanoparticles 1502 may diffuse to dark fringe regions. This may result in an organized distribution of nanoparticles 1502 in the polymer matrix 1504. FIG. 15C illustrates the cell of FIG. 15B after the top substrate 1510 has been removed.

FIG. 15D illustrates the cell of FIG. 15C after a second holographic layer 1512 is coated on top of the first holographic layer 1508. The second holographic layer 1512 may include a monomer material 1514 combined with nanoparticles 1516. The second holographic layer 1512 may be sandwiched between the first holographic layer 1508 and a top substrate 1518. FIG. 15E illustrates the cell of FIG. 15D after holographic exposure of the second holographic layer 1512. As with exposing the first holographic layer 1508, interference patterns may cause polymerization in bright fringes and the nanoparticles 1516 may diffuse to dark fringe regions. This may result in an organized distribution of nanoparticles 1516 in the polymer matrix 1514. FIG. 15F illustrates the cell of FIG. 15E after an ashing step. The ashing at least partially removes the polymer matrix 1514 of the second holographic layer 1512 and the polymer matrix 1504 of the first holographic layer 1508. This may create an multi-layer inorganic grating. In some embodiments, the nanoparticles 1514 may shift as the volume occupied by the polymer matrix 1504 is removed. Before ashing, the nanoparticles 1514 may be dispersed within the polymer matrix 1504 and upon removal of the polymer matrix 1504 spaced in between the nanoparticles 1514 there may be some shifting or reduction in thickness during ashing. Factors that affect the amount of shifting include the nanoparticle content (e.g. the ratio of nanoparticles 1514 to polymer matrix 1504), the size/shape/surface charge of the nanoparticles 1514, how much the nanoparticles 1514 have aggregated during holographic exposure (which could be influenced by nanoparticle capping agents, surface chemistry, or polymer cross-linking), and the overall shape of the structures recorded into the layer. This shifting may be comparable to shrinkage that takes place during polymerization, where monomers (that may take up more volume) are converted to polymers (which may take up less volume). The bulk of the structure may be maintained, but there may be some subtle shifting that may take place.

FIG. 15G illustrates the grating of FIG. 15F after an etching step. The etching step may be an e-beam or directional etching which may be used to remove a section 1520 of the grating. The removed section 1520 may create a cavity to form various grating structures such as a photonic crystal.

### Various Grating Configurations

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4k×4k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both 5-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes gratings having high S and P diffraction efficiency over certain wavelength and angle ranges for suitably chosen values of grating thickness (typically, in the range 2-5 μm).

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of forming a grating, the method comprising:
providing a starting cell comprising:
a bottom substrate;
a first removable substrate; and
a first holographic material comprising monomers and nanoparticles, wherein the first holographic material is positioned between the bottom substrate and the first removable substrate;
exposing the first holographic material with a holographic recording beam so the nanoparticles diffuse into dark fringe regions to create nanoparticle poor regions and nanoparticle rich regions to form a bottom grating;
removing the first removable substrate;
depositing a second holographic material on top of the exposed first holographic material;
positioning a second removable substrate on top of the second holographic material; and
exposing the second holographic material with another holographic recording beam to form a top grating.

2. The method of claim 1, wherein the bottom grating and the top grating have different slant directions.

3. The method of claim 1, wherein the bottom grating and the top grating have the same slant direction.

4. The method of claim 1, wherein the second holographic material comprises monomers and nanoparticle, and wherein exposing the second holographic material diffuses the nanoparticles into dark fringe regions to create nanoparticle poor regions and nanoparticle rich regions.

5. The method of claim 1, wherein the second holographic material comprises photopolymerizable monomers and inert liquid.

6. The method of claim 5, wherein the second holographic material further comprises nanoparticles.

7. The method of claim 6, wherein the inert liquid comprises a liquid crystal material.

8. The method of claim 7, wherein the nanoparticles are dispersed within the liquid crystal material.

9. The method of claim 1, further comprising providing a release layer on the surface of the first removable substrate contacting the first holographic material.

10. The method of claim 9, wherein the release layer comprises a silane-based fluoropolymer or fluoromonomer.

11. The method of claim 1, wherein exposing the first holographic material and the second holographic material with the holographic recording beam polymerizes the monomers to create a polymer matrix.

12. The method of claim 11, further comprising ashing the exposed first holographic material and second holographic material to remove at least a portion of the polymer matrix.

13. The method of claim 12, further comprising selectively etching a portion of the ashed first holographic material and second holographic material.

14. The method of claim 1, wherein the nanoparticles are selected from the group consisting of nanotubes, metals, insulators, ferroelectric materials, nanotubes, nanorods and nanospheres.

15. A method of forming a grating, the method comprising:
providing a starting cell comprising:
a bottom substrate;
a removable substrate; and
a holographic material comprising monomers and nanoparticles, wherein the holographic material is positioned between the bottom substrate and the removable substrate;
exposing the holographic material with a holographic recording beam so the nanoparticles diffuse into dark fringe regions to create nanoparticle poor regions and nanoparticle rich regions to form a grating;
removing the removable substrate; and
ashing the exposed holographic material to form a surface relief grating on top of a volume grating.

16. The method of claim 15, further comprising further ashing the exposed holographic material to form an inorganic grating structure made of the nanoparticles.

17. The method of claim 16, further comprising sintering the nanoparticles at a high temperature to remove grain boundaries between the nanoparticles.

18. The method of claim 17, further comprising coating an additional material onto the nanoparticles, wherein at least a portion of the additional material is positioned between adjacent nanoparticle rich regions.

19. The method of claim 18, further comprising depositing another holographic material on top of the additional material; and
exposing the other holographic material with another holographic recording beam to create a top grating.

20. A waveguide device comprising:
a waveguide supporting an input grating and a fold grating,
wherein the fold grating comprises alternating nanoparticle rich regions and nanoparticle poor regions, and
wherein the input grating comprises alternating liquid crystal rich regions and liquid crystal poor regions.

21. The waveguide device of claim 20, wherein the liquid crystal poor regions comprise air gaps.

22. The waveguide device of claim 20, wherein the nanoparticle poor regions comprise air gap regions on top of polymer matrix regions.

23. The waveguide device of claim 20, wherein the fold grating is an integrated multiplexed grating which functions as both a fold grating and an output grating.

24. The waveguide device of claim 20, wherein the alternating nanoparticle rich regions and nanoparticle poor regions include nanoparticles comprising a metal.

25. The waveguide device of claim 24, wherein the nanoparticles comprise a metal oxide core.

26. The waveguide device of claim 25, wherein the metal oxide core comprises ZrO₂, TiO₂, WO₃, ZnO, Co₃O₄, CuO, and/or NiO.

27. The waveguide device of claim 26, wherein the nanoparticles further comprise a ligand functionalized derivative of ZrO₂, TiO₂, WO₃, ZnO, Co₃O₄, CuO, and/or NiO which surrounds the metal oxide core.

28. The waveguide device of claim 24, wherein the metal comprises Pt, Au, and/or Ag.

29. The waveguide device of claim 24, wherein the nanoparticles are diameter less than 15 nm.

30. The waveguide device of claim 29, wherein the nanoparticles are diameter of about 4 nm to 10 nm.

31. The waveguide device of claim 20, wherein the alternating nanoparticle rich regions and nanoparticle poor regions include nanoparticles comprising a piezoelectric material.

32. The waveguide device of claim 31, wherein the piezoelectric material comprises PZT, barium titanate, and/or lithium niobate.

33. A waveguide device comprising:
a waveguide supporting a grating, wherein the grating comprises:
nanoparticle rich regions and nanoparticle poor regions, wherein the nanoparticle poor regions comprise air gap regions on top of polymer matrix regions,
wherein the air gap regions along with the nanoparticle rich regions on the same horizontal level make up a surface relief grating, and
wherein the polymer matrix regions along with the nanoparticle rich regions on the same horizontal level make up a volume grating.

34. A waveguide device comprising:
a waveguide supporting an inorganic grating, wherein the grating comprises:
nanoparticle rich regions, wherein nanoparticles in the nanoparticle rich regions are sintered at high temperature to remove grain boundaries between the nanoparticles; and
air gaps between adjacent nanoparticle rich regions.

35. A waveguide device comprising:
a waveguide supporting a multi-layered grating produced using the method of any one of claims 1-14.
